(19) United States
(12) Patent Application Publication
(10) Pub. No.: US 2018/0048450 A1
(43) Pub. Date: Feb. 15, 2018

(54) EXTENDED RANGE AND NON-EXTENDED RANGE OPERATIONAL MODE COEXISTENCE

(71) Applicant: QUALCOMM Incorporated, San Diego, CA (US)

(72) Inventors: Alireza Raissinia, Monte Sereno, CA (US); Ravi Gidvani, Fremont, CA (US); Ning Zhang, Saratoga, CA (US)

(21) Appl. No.: 15/672,528

(22) Filed: Aug. 9, 2017

Related U.S. Application Data
(60) Provisional application No. 62/372,786, filed on Aug. 9, 2016.

(51) Int. Cl. H04L 5/00; H04L 5/14; H04L 1/00

(52) U.S. Cl. CPC H04L 5/0055; H04L 1/0003; H04L 5/1438; H04L 1/0625

(57) ABSTRACT

Methods, systems, and devices for wireless communication are described. Wireless devices may use multiple transmission modes to enable association and authentication procedures for wireless devices with different capabilities. For example, a station may receive, in response to a broadcast probe request, a probe response frame formatted according to a first transmission mode. The station may then transmit a second probe request frame formatted according to the first transmission mode. At some later time, the station may identify that the second probe request frame was not received by the wireless device, and may transmit another probe request frame formatted according to an extended range transmission mode. The station may then establish a connection with the wireless device by completing an association and authentication procedure, and proceed to transmit data or control frames formatted according to the extended range transmission mode.

### CROSS REFERENCES

The present Application for Patent claims priority to U.S. Provisional Patent Application No. 62/372,786 by Raissinia, et al., entitled “Extended Range and Non-Extended Range Operational Mode Coexistence,” filed Aug. 9, 2016, assigned to the assignee hereof, and expressly incorporated by reference herein.

### BACKGROUND

The present disclosure relates to wireless communication, and more specifically to extended range and non-extended range operational mode coexistence.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a wireless local area network (WLAN), such as a Wi-Fi (e.g., Institute of Electrical and Electronics Engineers (IEEE) 802.11) network may include an access point (AP) that may communicate with one or more stations (STAs) or mobile devices. The AP may be coupled to a network, such as the Internet, and may enable a mobile device to communicate via the network (or communicate with other devices coupled to the AP). A wireless device may communicate with a network device bi-directionally. For example, in a WLAN, an STA may communicate with an associated AP via downlink and uplink. The downlink (or forward link) may refer to the communication link from the AP to the STA, and the uplink (or reverse link) may refer to the communication link from the STA to the AP.

Wireless devices with various capabilities may be present within a WLAN. For example, an STA may have the capability to use different transmission modes that enable communication with an AP or other wireless devices under different deployment and channel conditions. For example, different transmission modes may include the use of different frame formats. In some cases, an STA may not have the capability to use the same transmission modes as another STA, or may only be capable of a single transmission mode, and may thus have a limited ability to associate and communicate with other wireless devices under the same conditions. In other cases, the channel conditions experienced by a transmitting device may be different than the channel conditions experienced by a receiving device, such that communications transmitted by a first device may be successfully received by a second device in one transmission mode, but communications transmitted by the second device to the first device in the same transmission mode may not be successfully received by the first device. As a result, communications efficiency within the WLAN may benefit from techniques that enhance interoperability and increase communications flexibility between wireless devices having different capabilities.

### SUMMARY

The described techniques relate to improved methods, systems, devices, or apparatus that support extended range and non-extended range operational mode coexistence. Generally, the described techniques provide for the use of multiple transmission modes to enable association and authentication procedures for wireless devices with different capabilities. For example, a station (STA) may attempt to associate with a wireless device, such as an access point (AP) or a software enabled (or soft) access point (SAP), and broadcast a probe request. The STA may subsequently receive a probe response frame formatted in accordance with a first transmission mode. In response, the STA may transmit a second probe request frame formatted in accordance with the first transmission mode. At some later time (e.g., after a predetermined number of attempts), the STA may identify that the second probe request frame was not received by the wireless device, and transmit one or more additional probe request frames formatted in accordance with an extended range transmission mode. The STA may then establish a connection with the wireless device by completing the association and authentication procedure, and proceed to transmit data or control frames, formatted in accordance with the extended range transmission mode, to the wireless device. The wireless device may continue to transmit data or control frames to the STA formatted in accordance with the first transmission mode, or may switch to transmitting in the extended range transmission.

An apparatus for wireless communication is described. The apparatus may include a processor, memory in electronic communication with the processor, and instructions stored in the memory. The instructions may be operable, when executed by the processor, to cause the apparatus to broadcast a first probe request frame formatted according to an extended range transmission mode, receive, from a wireless device in response to the broadcast first probe request frame, a probe response frame formatted according to a first transmission mode, transmit, to the wireless device in response to the received probe response frame, a second probe request frame formatted according to the first transmission mode, identify that the transmitted second probe request frame formatted according to the first transmission mode was not received by the wireless device, and determine to transmit one or more third probe request frames to the wireless device formatted according to the extended range transmission mode based at least in part on identifying that the transmitted second probe request frame formatted according to the first transmission mode was not received by the wireless device.

A method of wireless communication is described. The method may include broadcasting a first probe request frame formatted according to an extended range transmission mode, receiving, from a wireless device in response to the broadcast first probe request frame, a probe response frame formatted according to a first transmission mode, transmitting, to the wireless device in response to the received probe response frame, a second probe request frame formatted according to the first transmission mode, identifying that the transmitted second probe request frame formatted according to the first transmission mode was not received by the wireless device, and determining to transmit one or more third probe request frames to the wireless device formatted according to the extended range transmission mode based at least in part on identifying that the transmitted second probe request frame formatted according to the first transmission mode was not received by the wireless device.

Some examples of the method and apparatus described above may further include processes, features, means, or instructions for completing an association and authentication procedure to establish a connection with the wireless device. Some examples of the method and apparatus described above may further include processes, features, means, or instructions for transmitting, to the wireless device, data or control frames formatted according to the extended range transmission mode while receiving, from the wireless device, data or control frames formatted according to the first transmission mode.

Some examples of the method and apparatus described above may further include processes, features, means, or instructions for monitoring a received signal strength indicator (RSSI) associated with frames received from the wireless device formatted according to the first transmission mode. Some examples of the method and apparatus described above may further include processes, features, means, or instructions for switching to transmitting, to the wireless device, frames formatted according to the first transmission mode based at least in part on determining that the monitored RSSI may have satisfied a predetermined threshold.

Some examples of the method and apparatus described above may further include processes, features, means, or instructions for selecting a transmission rate for the one or more third probe request frames formatted according to the extended range transmission mode from a rate adaptation table, wherein the transmission rate may be associated with the wireless device and the extended range transmission mode. In some examples of the method and apparatus described above, the rate adaptation table comprises, for each of a plurality of wireless devices, a first transmission rate associated with the first transmission mode and a second transmission rate associated with the extended range transmission mode.

In some examples of the method and apparatus described above, the selected transmission rate may be selected from a plurality of transmission rates of the rate adaptation table, each respective transmission rate specific to one or more of a plurality of wireless devices. Some examples of the method and apparatus described above may further include processes, features, means, or instructions for receiving, from the wireless device, a frame formatted according to the extended range transmission mode. Some examples of the method and apparatus described above may further include processes, features, means, or instructions for determining, based at least in part on the received frame, whether to transmit, to the wireless device, a control response frame formatted according to the first transmission mode or formatted according to the extended range transmission mode. Some examples of the method and apparatus described above may further include processes, features, means, or instructions for transmitting, to the wireless device, the control response frame formatted according to the first transmission mode or formatted according to the extended range transmission mode based at least in part on the determination.

Some examples of the method and apparatus described above may further include processes, features, means, or instructions for selecting a transmission rate for the control response frame based at least in part on the determination, wherein the transmission rate may be selected from one or more transmission rates for the first transmission mode or selected from one or more transmission rates for the extended range transmission mode. Some examples of the method and apparatus described above may further include processes, features, means, or instructions for switching, after a completed association and authentication procedure, between transmitting frames according to the first transmission mode, or the extended range transmission mode, or a combination thereof, based at least in part an operational mode indicator within a frame from the wireless device.

Some examples of the method and apparatus described above may further include processes, features, means, or instructions for roaming between a first basic service set identifier (BSSID) corresponding to the first transmission mode and a second BSSID corresponding to the extended range transmission mode, wherein the roaming may be based at least in part on a roaming algorithm. Some examples of the method and apparatus described above may further include processes, features, means, or instructions for transmitting, to the wireless device, an indication that the first transmission mode or the extended range transmission mode will be used by a station for subsequent frame transmissions.

Some examples of the method and apparatus described above may further include processes, features, means, or instructions for transmitting, to the wireless device, one or more subsequent frames for an association and authentication procedure according to the extended range transmission mode while receiving, from the wireless device, frames for the association and authentication procedure formatted according to the first transmission mode, or the extended range transmission mode, or a combination thereof. Some examples of the method and apparatus described above may further include processes, features, means, or instructions for receiving one or more subsequent frames from the wireless device, wherein the one or more subsequent frames comprise a first frame formatted according to the first transmission mode or the first frame formatted according the extended range transmission mode, and wherein receiving the one or more subsequent frames may be based at least in part on identifying a BSSID corresponding to the first frame.

Some examples of the method and apparatus described above may further include processes, features, means, or instructions for determining to transmit each of one or more subsequent frames formatted according to the first transmission mode, or the extended range transmission mode, or a combination thereof. Some examples of the method and apparatus described above may further include processes, features, means, or instructions for transmitting, to the wireless device, the one or more subsequent frames formatted according to the first transmission mode, or the extended range transmission mode, or a combination thereof based at least in part on the determination.

In some examples of the method and apparatus described above, the received probe response frame formatted according to the first transmission mode comprises at least a directed probe response, or an authentication response, or an association response, or a clear-to-send-to-self (CTS2S) transmission, or a request-to-send (RTS) transmission, or a combination thereof. In some examples of the method and apparatus described above, the second probe request frame formatted according to the first transmission mode comprises at least an acknowledgement, or a block acknowledgement, or a clear-to-send (CTS) transmission, or combination thereof. In some examples of the method and apparatus described above, the apparatus may be a wireless communication terminal and further comprises an antenna and a transceiver.

An apparatus for wireless communication is described. The apparatus may include a processor, memory in electronic communication with the processor, and instructions stored in the memory. The instructions may be operable, when executed by the processor, to cause the apparatus to receive, from a station, a broadcast first probe request frame formatted according to an extended range transmission mode, transmit, a first probe response frame in response to the received broadcast probe request frame, the first probe response frame formatted according to a first transmission mode, receive, from the station in response to the first probe response frame, a second probe request frame formatted according to the extended range transmission mode, determine, based at least in part on the received second probe request frame, whether to transmit, to the station, one or more subsequent probe response frames formatted according to the first transmission mode, or according to the extended range transmission mode, or formatted according to a combination thereof, and transmit the one or more subsequent probe response frames to the station based at least in part on the determination.

A method of wireless communication is described. The method may include receiving, from a station, a broadcast first probe request frame formatted according to an extended range transmission mode, transmitting, a first probe response frame in response to the received broadcast probe request frame, the first probe response frame formatted according to a first transmission mode, receiving, from the station in response to the first probe response frame, a second probe request frame formatted according to the extended range transmission mode, determining, based at least in part on the received second probe request frame, whether to transmit, to the station, one or more subsequent probe response frames formatted according to the first transmission mode, or according to the extended range transmission mode, or formatted according to a combination thereof, and transmitting the one or more subsequent probe response frames to the station based at least in part on the determination.

In some examples of the method and apparatus described above, transmitting the one or more subsequent probe response frames comprises: transmitting a first frame formatted according to the first transmission mode. Some examples of the method and apparatus described above may further include processes, features, means, or instructions for transmitting the first frame formatted according to the extended range transmission mode, wherein the first frame formatted according to the extended range transmission mode may be separated from the first frame formatted according to the first transmission mode by a predefined interval.

Some examples of the method and apparatus described above may further include processes, features, means, or instructions for selecting a transmission rate for the one or more subsequent probe response frames from a rate adaptation table, wherein the transmission rate may be associated with the station and the extended range transmission mode.

### BRIEF DESCRIPTION OF THE DRAWINGS

FIG. 1 illustrates an example of a wireless local area network (WLAN) that supports extended range and non-extended range operational mode coexistence in accordance with aspects of the present disclosure.

FIG. 2 illustrates an example of a WLAN that supports extended range and non-extended range operational mode coexistence in accordance with aspects of the present disclosure.

FIG. 3 illustrates an example of frame transmissions that support extended range and non-extended range operational mode coexistence in accordance with aspects of the present disclosure.

FIGS. 4 through 7 illustrate examples of process flows in a system that supports extended range and non-extended range operational mode coexistence in accordance with aspects of the present disclosure.

FIGS. 8 through 10 show block diagrams of a device that supports extended range and non-extended range operational mode coexistence in accordance with aspects of the present disclosure.

FIG. 11 illustrates a block diagram of a system including a station that supports extended range and non-extended range operational mode coexistence in accordance with aspects of the present disclosure.

FIGS. 12 through 14 show block diagrams of a device that supports extended range and non-extended range operational mode coexistence in accordance with aspects of the present disclosure.

FIG. 15 illustrates a block diagram of a system including a wireless device that supports extended range and non-extended range operational mode coexistence in accordance with aspects of the present disclosure.

FIGS. 16 through 19 illustrate methods for extended range and non-extended range operational mode coexistence in accordance with aspects of the present disclosure.

### DETAILED DESCRIPTION

In some wireless communications systems, different transmission modes (e.g., the use of different frame formats) may be used in different deployment scenarios, such as when wireless devices communicate over asymmetric or symmetric links, or for peer-to-peer (P2P) communications. For example, a station (STA) and an access point (AP) may both initially use a first transmission mode, such as a non-extended range transmission mode (e.g., a transmission mode using legacy frame formats, multi-user frame formats, trigger-based frame formats, other frame formats in forthcoming IEEE 802.11 versions, etc.) to communicate, where the STA may receive transmissions from the AP, but the AP may not be able to receive transmissions from the STA (e.g., downlink system gain may be higher than an uplink system gain (e.g., an asymmetric link)). As a result of the asymmetric link, the STA may determine to switch to a second transmission mode (e.g., an extended range transmission mode using an extended range physical layer convergence procedure (PLCP) protocol data unit (PPDU) format) while the AP continues to transmit using the first transmission mode. In some cases, based on the STA's use of the extended range transmission mode, the AP may similarly use an extended range transmission mode when communicating with the STA, and may communicate with other STAs using a non-extended range transmission mode.

In other examples, different wireless devices (such as an STA and a software enabled access point (SoftAP or SAP)) may hear each other when using an extended range transmission mode, but not when using a non-extended range transmission mode, where both wireless devices may communicate using the extended range transmission mode following association. For instance, the STA and SAP may share a symmetric link (e.g., uplink system gain is equal to or approximately the same as downlink system gain). Both wireless devices may exchange control response frames to received extended range transmission mode PPDUs. Additionally, the extended range transmission mode may be used when a first STA communicates with another STA (e.g., peer-to-peer communication). In such cases, the extended range transmission mode may be used for both discovery and data transmissions by the two STAs (e.g., for neighbor awareness networking (NAN), independent basic service sets (IBSS), etc.). For example, each STA may have a symmetric link and use the extended range transmission mode to establish a NAN cluster (e.g., perform NAN formation, synchronization, beaconing, service discovery, NAN data link (NDL), etc.).

The use of different transmission modes described above may enable an STA to associate and communicate with an AP or an SAP. That is, through an exchange of association request frames, association response frames, and acknowledgment (ACK) frames, an STA and an AP may determine a transmission mode to complete an association and authentication procedure, and may proceed with data transmission using the determined transmission mode. In some cases, a wireless device using an extended range transmission mode may determine to switch to a non-extended range transmission mode (e.g., a transmission mode that uses a frame format other than an extended range PPDU). As an example, a wireless device (e.g., an STA, an SAP, etc.) may monitor a received signal strength indicator (RSSI) to determine if a link quality has changed after associating with an AP using the extended range transmission mode. If the link quality has improved, the device may attempt to transmit using a non-extended range transmission mode.

Aspects of the disclosure are initially described in the context of a wireless communications system. Examples are then provided of association and authentication procedures between wireless devices using different transmission modes. Aspects of the disclosure are further illustrated by and described with reference to apparatus diagrams, system diagrams, and flowcharts that relate to full bandwidth multicast indication to multiple users.

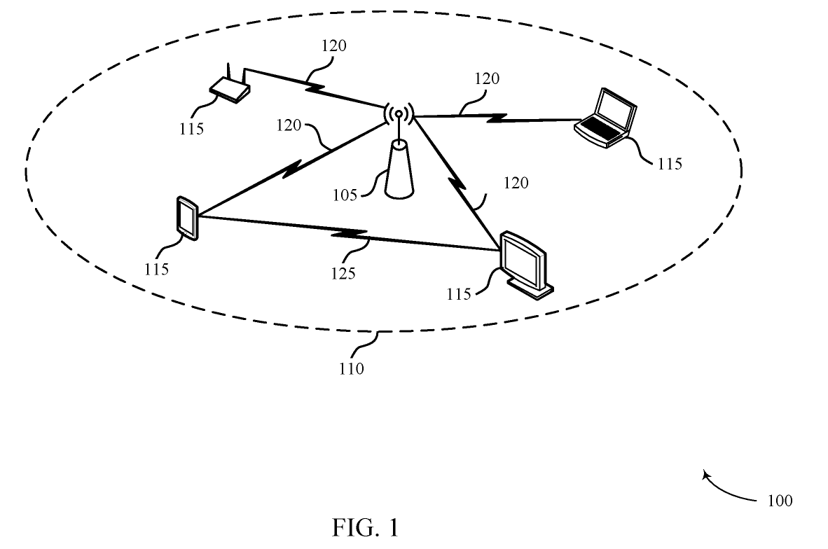

FIG. 1 illustrates a wireless local area network (WLAN) 100 (also known as a Wi-Fi network) configured in accordance with aspects of the present disclosure. The WLAN 100 may include an AP 105 and multiple associated STAs 115, which may represent devices such as wireless communication terminals, including mobile stations, phones, personal digital assistant (PDAs), other handheld devices, netbooks, notebook computers, tablet computers, laptops, display devices (e.g., TVs, computer monitors, etc.), printers, etc. The AP 105 and the associated STAs 115 may represent a basic service set (BSS) or an extended range service set (ESS). The various STAs 115 in the network are able to communicate with one another through the AP 105. Also shown is a coverage area 110 of the AP 105, which may represent a basic service area (BSA) of the WLAN 100. An extended range network station associated with the WLAN 100 may be connected to a wired or wireless distribution system that may allow multiple APs 105 to be connected in an ESS. WLAN 100 may support the use of techniques that enable the interoperability of wireless devices that are capable of different transmission modes, such as the ability to communicate using different PPDU formats (e.g., a high efficiency (HE) extended range PPDU format).

In some cases, a STA 115 may be located in the intersection of more than one coverage area 110 and may associate with more than one AP 105. A single AP 105 and an associated set of STAs 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two STAs 115 may also communicate directly via a direct wireless link 125 regardless of whether both STAs 115 are in the same coverage area 110. Examples of direct wireless links 125 may include Wi-Fi Direct connections, Wi-Fi Tunneled Direct Link Setup (TDLS) links, and other group connections. STAs 115 and APs 105 may communicate according to the WLAN radio and baseband protocol for physical (PHY) and medium access control (MAC) layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc. In other implementations, peer-to-peer connections or ad hoc networks may be implemented within the WLAN 100. Devices in WLAN 100 may communicate over unlicensed spectrum, which may be a portion of spectrum that includes frequency bands traditionally used by Wi-Fi technology (e.g., technology using IEEE 802.11 communication protocols), such as the 5 GHz band, the 2.4 GHz band, the 60 GHz band, the 3.6 GHz band, and/or the 900 MHz band. Unlicensed spectrum may also include other frequency bands.

An AP 105 may communicate with a STA 115 via uplink and downlink. Uplink transmissions may refer to transmissions from the STA 115 to the AP 105 and downlink transmissions may refer to transmissions from the AP 105 to the STA 115. A number of communication techniques may be used for the uplink and downlink transmissions. For example, a wireless device (e.g., an AP 105) may implement beamforming in which the energy of a transmission is focused in a particular direction (e.g., towards a STA 115, or a set of STAs 115). In some cases, multiple-input-multiple output (MIMO) techniques may be used when the AP 105 and/or STA 115 involved in communications includes multiple antennas. For example, uplink/downlink single-user MIMO (SU-MIMO) may include multiple streams of data that are simultaneously communicated to another wireless device (e.g., from an AP 105 to a STA 115) using multiple antennas and beamforming techniques. In multi-user MIMO (MU-MIMO), for example downlink MU-MIMO, an AP 105 may simultaneously send multiple streams to multiple STAs 115 by taking advantage of spatial diversity in transmission resources and multiple antennas. In some cases, uplink and/or downlink MU-MIMO may be used.

In some cases, an AP 105 and a STA 115 may be located at distances that impact efficient communications. For example, a STA 115 may be far enough away from an AP 105 that a transmitted signal does not have sufficient power to be correctly identified by a receiving device. As a result, an extended range PPDU that supports transmission at greater distances (e.g., an HE-EXT-SU-PPDU) may be used for communications between wireless devices in WLAN 100 to improve transmission reliability. As an example, an extended range PPDU may be formatted such that predetermined fields have boosted power and/or have a different length than those corresponding to other PPDUs (e.g., some fields within the PPDU may be repeated). Additionally or alternatively, the extended range PPDU may be associated with single-user transmissions.

In WLAN 100, wireless devices with different capabilities may use multiple transmission modes to complete association and authentication procedures. For example, a STA 115 may attempt to associate with a wireless device, such as an AP 105 or an SAP, and receive an association response frame formatted in accordance with a first transmission mode. In response, the STA 115 may transmit an ACK frame or an association request frame formatted in accordance with the first transmission mode. At some later time (e.g., after a predetermined number of attempts), the STA 115 may identify that the ACK or association request frame was not received by the wireless device, and transmit another association request frame formatted in accordance with an extended range transmission mode (e.g., utilizing an extended range PPDU). The STA 115 may then establish a connection with the wireless device by completing the association and authentication procedure, and proceed to transmit data or control frames formatted in accordance with the extended range transmission mode.

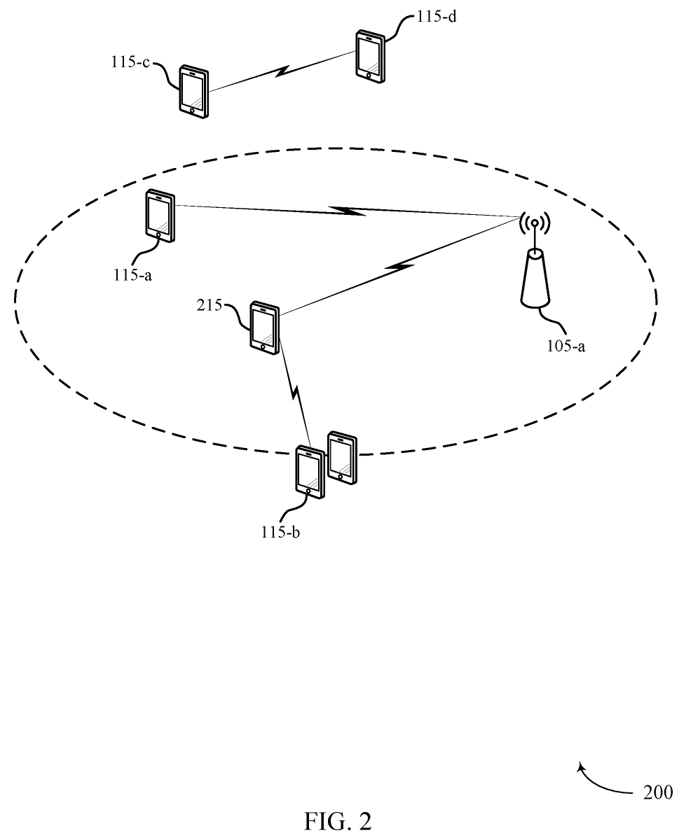

FIG. 2 illustrates an example of WLAN 200 that supports extended range and non-extended range operational mode coexistence in accordance with aspects of the present disclosure. WLAN 200 includes AP 105-a and STAs 115-a through 115-d, which may be examples of an AP 105 and STAs 115 described with reference to FIG. 1. WLAN 200 may also include SAP 215 which may be an example of a STA 115 described with reference to FIG. 1. WLAN 200 may be an example of a system that supports interoperability of wireless devices with different capabilities, and may further enable efficient authentication and association processes for such wireless devices.

In some cases, SAP 215 may act as an AP for one or multiple STAs 115, such as STAs 115-b. In some cases, STAs 115-b may be located outside of the coverage area of AP 105-a, and may indirectly communicate with AP 105-a through SAP 215. Additionally or alternatively, STAs 115-b may be located a distance away from SAP 215 that allows for communication using a non-extended range or an extended range transmission mode. Additionally, SAP 215 may be located a distance away from AP 105-a that allows for communication using the extended range transmission mode, while communicating with STAs 115-b using a non-extended range transmission mode.

WLAN 200 may support the coexistence of wireless devices with different capabilities, where multiple transmission modes may be used for different scenarios, such as when wireless devices communicate over symmetric or asymmetric links, or for peer-to-peer communications. For example, using a first transmission mode (e.g., a non-extended range transmission mode using non-extended range PPDUs formats), STA 115-a may be able to receive transmissions from AP 105-a (or SAP 215), but AP 105-a may not be able to receive transmissions from STA 115-a (e.g., a downlink system gain may be higher than an uplink system gain (e.g., an asymmetric link)). As a result, STA 115-a may determine to switch to an extended range transmission mode (e.g., a transmission mode using an extended range PPDU format) while AP 105-a continues to use the first transmission mode (or may also switch to using the extended range transmission mode).

In another example, different wireless devices, e.g., STA 115-a and SAP 215, may only be able to successfully decode transmission from the other (e.g., receive communications at a high enough power) when using an extended range transmission mode. That is, STA 115-b and SAP 215 may have a symmetric downlink and uplink system gain (e.g., uplink system gain is equal or approximately equal to downlink system gain), and therefore, both STA 115-a and SAP 215 may transmit using the extended range transmission mode for association and communication when the non-extended range transmission mode is not successful. In such cases, beacon signals, as well as broadcast and multicast data, may also be sent using the extended range transmission mode. Additionally or alternatively, dual clear-to-send-to-self (CTS2S) frames may be used to provide network allocation vector (NAV) protection for the transmitting wireless device (e.g., using both extended range and non-extended range transmission modes). In some cases, SAP 215 may start sending beacons using a non-extended range transmission mode until SAP 215 detects at least one STA 115 that is associated with an extended range transmission mode. Once at least one STA 115 using the extended range transmission mode is detected, SAP 215 may begin transmitting beacons formatted in accordance with both transmission modes.

Beacons transmitted using the different formats may be separated by a predetermined duration (e.g., 50 time units) and use different BSS identifiers (BSSIDs) (e.g., one format may use one BSS identification while another format uses a different BSS identification). In some cases, broadcast and multicast frames may also be transmitted in each delivery traffic indication message (DTIM) period using both PPDU formats and may be sent after transmission of a beacon. In some cases, STAs 115 may only receive transmissions (e.g., beacons, broadcast frames, multicast frames) using the same PPDU format (e.g., extended range or non-extended range) as the format that they are configured to use. An authentication and association procedure may then occur and a determination of which format to configure a STA 115 and SAP 215 to for communications may be made. If a determination is made to use an extended range transmission mode, SAP 215 may remove the STA 115 that is using the extended range transmission mode from MU operation while continuing MU operation with other STAs 115 using a non-extended range transmission mode. Additionally or alternatively, both SAP 215 and STAs 115 may use a dual CTS2S as a protection mechanism.

In another example, extended range transmission modes may be used for communication between STA 115-c and STA 115-d, which may not be associated with AP 105-a (e.g., peer-to-peer communication). The extended range transmission mode may be used for both discovery and data transmissions between STA 115-c and STA 115-d (such as for NAN, IBSS, etc.). STA 115-c and STA 115-d may have a symmetric downlink and uplink system gain and may use the extended range transmission mode to establish a NAN cluster (e.g., perform NAN formation, synchronization, beaconing, service discovery, NDL, etc.).

In some cases, uplink system gain and downlink system gain between STA 115-c and STA 115-d may be approximately equal, but STA 115-c and STA 115-d may be too far away to communicate with one another reliably using a non-extended range transmission mode. Therefore, STA 115-c and STA 115-d may be configured to operate using an extended range transmission mode. As an example, an extended range transmission mode may be used to transmit synchronization beacons, send a service discovery frame (SDF), perform peer-to-peer ranging, indicate NDL scheduling, and communicate data transmissions. Additionally or alternatively, NAN peer-to-peer connectivity may be intended for non-associated devices (e.g., such as STA 115-c and STA 115-d) that may not perform a BSS association procedure.

In some cases, a rate adaptation table may be used when communicating using different transmission modes. As an example, a transmission rate may be selected from a rate adaptation table after STA 115-a switches from using a non-extended range transmission mode to using an extended range transmission mode (e.g., after receipt of a probe response from an AP, when sending a control response frame (such as an ACK, or a negative ACK (NACK or NAK)), etc.). The rate adaptation table may be used when sending a control response to a specific address (e.g., an address of AP 105), even if received transmissions use the non-extended range transmission mode. In some cases, a rate adaptation table entry may be combined with address station table (AST) logic, and multiple extended range control response rates (e.g., two or more response rates) may be supported per peer (e.g., each AP 105, SAP 215, etc.). Multiple peers (e.g., two APs 105) may also be supported for different transmission rates.

In some cases, STA 115-a may identify AP 105-a using one or more scanning techniques. That is, STA 115-a may perform a passive scan or an active scan to identify AP 105-a. If a passive scan is performed, STA 115-a may listen for a predetermined duration (e.g., listen for 120 ms). Additionally or alternatively, if an active scan is performed using an extended range transmission mode, an immediate query may be made to AP 105. In some cases, STA 115-a may be configured to respond to frames formatted in accordance with the extended range transmission mode with a control response frame (e.g., ACK frames, block acknowledgement (BA) frames, or clear-to-send (CTS) frames, etc.) also formatted in accordance with the extended range transmission mode.

STA 115-a and AP 105-a may update a setting for a NAV associated with transmissions. As an example, STA 115-a may be configured to operate using an extended range transmission mode (e.g., a transmission mode associated with the transmission of one or more extended range PPDUs). Therefore, STA 115-a may determine that the extended range transmission mode may be used for control responses and set a NAV accordingly. However, AP 105-a may not be using the extended range transmission mode for sending control responses. Thus, AP 105-a may not use the entire NAV. In some cases, AP 105-a may transmit using a non-extended range transmission mode and may communicate with STA 115-a using an extended range transmission mode to determine a setting for a NAV protection mechanism (e.g., set the NAV so that it covers control responses using the extended range transmission mode from STA 115-a). Dual CTS2S may also be used to determine the setting for the NAV protection mechanism, so as to avoid other wireless devices that may not be able to decode frames formatted in accordance with the extended range transmission mode, which may cause a transmission collision.

An operational mode indicator (OMI) may be used to inform a wireless device about capabilities of another wireless device. For example, AP 105-a may transmit an OMI to STA 115-a to indicate that AP 105-a may communicate using a selected transmission mode. STA 115-a may similarly transmit the OMI to AP 105-a to indicate transmission mode capabilities for STA 115-a. The OMI may contain a number of bits (e.g., 2 bits) that are used to convey configuration information. As an example, a bit may be used to indicate the transmission mode of STA 115-a. That is, the bit may indicate whether STA 115-a is using an extended range transmission mode or a non-extended range transmission mode (e.g., 0 may indicate a first transmission mode while 1 may indicate another transmission mode). Another bit may be used to indicate whether STA 115-a is configured to receive response control frames using the extended range transmission mode or the non-extended range transmission mode. In some cases, STA 115-a may use an OMI to inform AP 105-a about a new configuration when switching PPDU formats. STA 115-a and AP 105-a may exchange capabilities (e.g., communication of OMIs) to ensure that PPDUs having a non-extended range transmission format have a proper NAV setting for control response frames sent using either transmission mode.

In some cases, AP 105-a may be informed about use of an extended range transmission mode by STA 115-a. Additionally or alternatively, the format being used may be detected by AP 105-a. AP 105-a may determine whether to include STA 115-a in transmissions using a trigger-based PPDU with a smaller resource unit (e.g., the determination may be heuristic) or AP 105-a may determine to not include STA 115-a in multiple-user transmissions. In some cases, if AP 105-a is configured to send all subsequent transmissions to STA 115-a using the extended range transmission mode, STA 115-a may not need to learn the address of AP 105-a to create a rate adaptation table entry (e.g., because the rate may follow a global rate ACK process).

A wireless device using an extended range transmission mode may make a determination to switch to a non-extended range transmission mode. As an example, STA 115-a may monitor a beacon received signal strength indicator (RSSI) to determine if a link quality has changed. If the link quality has improved by a predetermined amount (e.g., increased by 5-6 dB), STA 115-a may attempt to transmit using a non-extended range transmission mode. A determination may then be made to continue to transmit using the non-extended range transmission mode (e.g., if the transmissions were successfully received over a given duration). In some cases, when STA 115-a switches back to using a non-extended range transmission mode, STA 115-a may manage an ACK rate entry table associated with AP 105-a (e.g., up to a predetermined limit) by using a robust non-extended range transmission mode. Having an ACK rate entry table per peer may also improve downlink performance, e.g., rate versus range (known as RvR). For example, STA 115-a may start with a robust ACK or BA rate just after STA 115-a transitions from the extended range transmission mode to the non-extended range transmission mode as the link may be imbalanced at that time (e.g., STA 115-a may make modifications to improve range by reducing the ACK rate). STA 115-a may then change the ACK rate to higher order modulation as the link improves. When STA 115-a switches back to using the non-extended range transmission mode, STA 115-a may also inform AP 105-a of the changed PPDU format (e.g., using an OMI header).

In some cases, when switching from an extended range transmission mode to a non-extended range transmission mode, STA 115-a may utilize a roaming algorithm or roaming policy to roam from a BSSID associated with the extended range transmission mode to a BSSID associated with a non-extended range transmission mode. For example, STA 115-a may use a roaming algorithm to move from a first BSSID corresponding to an AP 105 using the extended range transmission mode to BSSID corresponding to an AP 105 using the non-extended range transmission mode when an RSSI improves. In some cases, STA 115-a may determine that the two BSSIDs correspond to the same AP 105. STA 115-a may also utilize a roaming algorithm or policy to switch from a BSSID associated with a non-extended range transmission mode to a BSSID associated with an extended range transmission mode.

Wireless devices may be configured to enable the transmission of different frames using different transmission modes. As an example STAs 115, SAP 215, and AP 105-a may be configured to send a control frame (e.g., an ACK, a BA, or a CTS) using an extended range transmission mode upon receipt of a PPDU using the extended range format. Additionally or alternatively, STA 115, SAP 215, and AP 105-a may be configured to determine which format to send a control frame using, depending on the format of a received PPDU. In some cases, AP 105-a may be configured to transmit using a non-extended range transmission mode regardless of what format a received PPDU used. Additionally or alternatively, STA 115-a may also be configured to selectively send a control response frame using an extended range transmission mode to a specific peer (e.g., AP 105-a) even if STA 115-a receives a transmission using a non-extended range transmission mode from the peer.

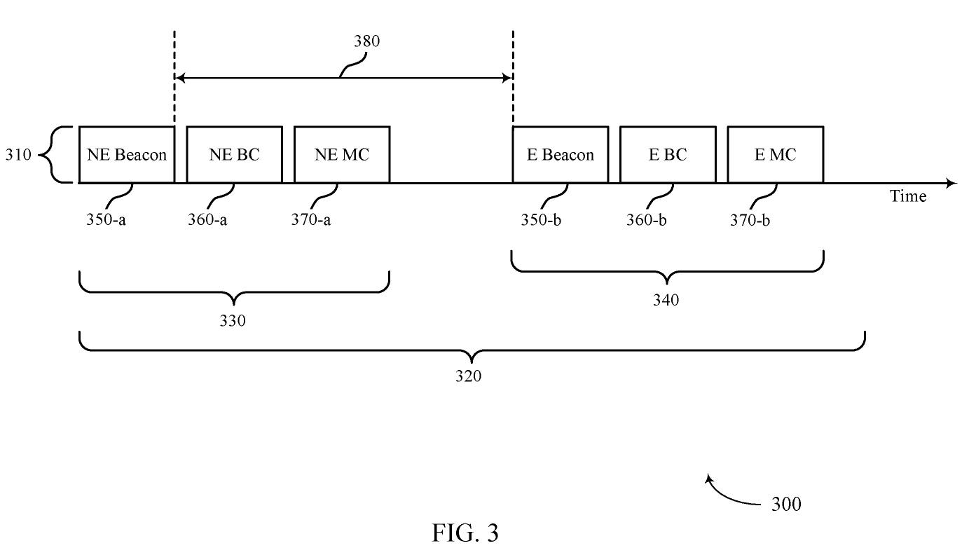

FIG. 3 illustrates frame transmissions 300 that support extended range and non-extended range operational mode coexistence in accordance with aspects of the present disclosure. Frame transmissions 300 may be an example of multiple transmissions by an AP 105 or by an SAP 215 as described with reference to FIGS. 1 and 2. That is, frame transmissions 300 may include the transmission of frames 310 to a STA 115 or other wireless device, where the frames 310 may be formatted in accordance with different transmission modes. For example, frames 310 may include multiple transmissions of a beacon, or multicast data, or broadcast data formatted in accordance with an extended range transmission mode or a non-extended range transmission mode. In some examples, frames 310 may be transmitted by a SAP 215 that is in communication with multiple STAs 115 with different capabilities. As a result, the SAP 215 may transmit multiple beacons, or may broadcast or multicast data for the different STAs 115 within a predefined time period.

For example, frames 310 may be transmitted within DTIM period 320, which may be an interval during which STAs 115 in a power saving mode may wake up to receive frames 310. Within DTIM period 320, an SAP 215 may transmit a first set of frames 330 formatted in accordance with a first transmission mode (e.g., a non-extended range transmission mode), and a second set of frames 340 formatted in accordance with an extended range transmission mode.

The first set of frames 330 may be used to provide control information and other indications (e.g., information on the presence of buffered multicast or broadcast data) to the STAs. In some cases, the first set of frames 330 may include a non-extended range transmission mode beacon 350-a, non-extended range transmission mode broadcast data 360-a, non-extended range transmission mode multicast data 370-a, or any combination thereof. The second set of frames 340 may include an extended range transmission mode beacon 350-b, extended range transmission mode broadcast data 360-b, extended range transmission mode multicast data 370-b, or any combination thereof. In some cases, a frame 310 transmitted in the second set of frames 340 may be separated from a corresponding frame 310 transmitted in the first set of frames 330 by a predefined time period 380. For example, extended range transmission mode beacon 350-b may be transmitted a predefined time period 380 (e.g., 50 time units) after non-extended range transmission mode beacon 350-a.

In some examples, an SAP 215 may send the first set of frames 330 formatted in accordance with the first transmission mode until the SAP 215 detects at least one STA 115 completing an association and authentication procedure using an extended range transmission mode. As a result, the SAP 215 may send the first set of frames 330 formatted in accordance with the first transmission mode and the second set of frames 340 formatted in accordance with the extended range transmission mode. The second set of frames 340 may include the same information as the first set of frames 330, but each set may only be received by STAs 115 using the respective transmission mode. For instance, a STA 115 may use a BSSID to receive the respective frames 310 formatted in accordance with the transmission mode that the STA 115 is using. That is, the first set of frames 330 may correspond to a first BSS and the second set of frames 340 may correspond to a second BSS. As a result, the STA 115 may avoid receiving the duplicate frames within each set by using the BSSID for the set that is associated with transmission mode currently in use at the STA 115.

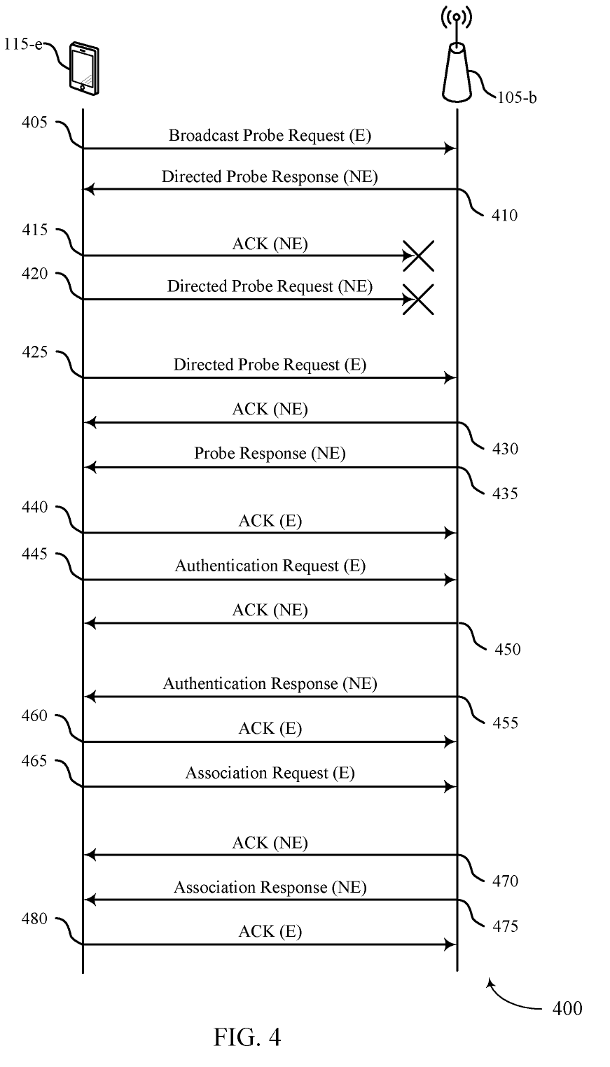

FIG. 4 illustrates an example of a process flow 400 in a system that supports extended range and non-extended range operational mode coexistence in accordance with aspects of the present disclosure. In some cases, process flow 400 may include STA 115-e and AP 105-b, which may be examples of the corresponding devices described with reference to FIGS. 1-2. Although some of the below examples describe features performed by an AP 105, these features may also be performed by a STA 115, or by an SAP 215, as described with reference to FIG. 2.

In some examples, STA 115-e and AP 105-b may be configured to operate using different transmission modes based on received frames that are formatted in accordance with a first transmission mode (e.g., a non-extended range transmission mode) or an extended range transmission mode. For example, AP 105-b may be configured to send all PPDUs (e.g., beacon, management, data, etc.) excluding control response frames (e.g., ACK frames, BA frames, CTS frames, etc.) formatted according to the non-extended range transmission mode. That is, upon receipt of a frame formatted according to the extended range transmission mode from STA 115-e, AP 105-b may be configured to send a control response frame using the extended range transmission mode back to STA 115-e (e.g., while continuing to transmit frames formatted according to the non-extended range transmission mode to other STAs 115).

In other examples, AP 105-b may be configured to send all PPDUs, including control response frames, using the non-extended range transmission mode or using the extended range transmission mode. In such cases, a control response transmission rate selection may be based on a baseline standard (e.g., a rate may be 1 Mbps using 2.4 GHz and 6 Mbps using 5 GHz). In some examples, a NAV setting may benefit from the use of the non-extended range transmission mode for control response frames (e.g., a shorter NAV duration may be set that is supported by all wireless devices), and use of the extended range transmission mode may be disabled for AP 105-b. In some cases, process flow 400 may illustrate an example of an authentication and association process, where STA 115-e may connect with AP 105-b using an asymmetric link.

At 405, STA 115-e may broadcast a probe request to a number of nearby APs 105 (e.g., including AP 105-b), where the broadcast probe request is formatted according to an extended range transmission mode. The broadcast probe request may be received by AP 105-b, and at 410, AP 105-b may transmit, and STA 115-e may receive, an association response frame (e.g., a directed probe response) formatted according to the non-extended range transmission mode. In such cases, AP 105-b may be configured to send association response frames formatted according to the non-extended range transmission mode even if AP 105-b receives frames formatted according to the extended range transmission mode from STA 115-e. At 415, STA 115-e may transmit an ACK frame in response to the received association response frame received at 410. The ACK frame may be formatted according to the non-extended range transmission mode.

In some cases, STA 115-e may identify that the transmitted ACK frame formatted according to the first transmission mode was not received by AP 105-b (e.g., after a number of tries). For instance, STA 115-e may be located at a distance apart from AP 105-b such that the ACK frame transmission was not received at AP 105-b. In some cases, at 420, STA 115-e may transmit an association request frame (e.g., a directed probe request) to AP 105-b. Transmitting the association request frame may include broadcasting or multicasting the frame by STA 115-e. The association request frame may be formatted according to the non-extended range transmission mode in response to the received association response frame. That is, STA 115-e may send the directed probe request using the non-extended range transmission mode because a previous directed probe response was formatted according to the non-extended range transmission mode. In some examples, if the directed probe request is successfully received at AP 105-b (e.g., a directed probe response is received back from AP 105-b), STA 115-e may proceed with an authentication and association procedure using the non-extended range transmission mode, such as may be the case when STA 115-e is a mobile device and moved closer to AP 105-b (since STA 115-e initially sent a probe request formatted according to the extended range transmission mode). In other examples, STA 115-e may identify that the transmitted association request frame formatted according to the first transmission mode was not received by AP 105-b.

At 425, STA 115-e may subsequently transmit, and AP 105-b may receive, a probe request frame (e.g., a directed probe request) formatted according to the extended range transmission mode. In such cases, the extended range transmission mode may be used when STA 115-e determines that a preceding frame formatted according to the non-extended range transmission mode (e.g., transmitted at 420) was not received at AP 105-b. At 430, AP 105-b may transmit an ACK to confirm receipt of the directed probe request, and at 435, AP 105-b may transmit an association response frame (e.g., a probe response) in response to the received probe request frame. In some cases, and as mentioned above, AP 105-b may continue to transmit using the non-extended range transmission mode even after receipt of the directed probe request (or other frames) formatted in accordance with the extended range transmission mode.

At 440, STA 115-e may transmit an ACK frame formatted according to the extended range transmission mode in response to the received association response frame, and STA 115-e may proceed with the transmission of an authentication request formatted according to the extended range transmission mode at 445. AP 105-b may transmit an ACK frame at 450, and transmit an authentication response at 455. STA 115-e may then transmit an ACK frame formatted according to the extended range transmission mode at 460, and transmit a subsequent association request formatted according to the extended range transmission mode at 465.

AP 105-b may confirm receipt of the association request with an ACK at 470, and may respond with an association response at 475. Finally, at 480, an ACK frame formatted according to the extended range transmission mode may be sent by STA 115-e and subsequent communications may take place between the wireless devices.

In some cases, AP 105-b may be informed about use of an extended range transmission mode by STA 115-e or AP 105-b may be able to detect that STA 115-e is using the extended range transmission mode (e.g., due to SU transmissions received from STA 115-e). AP 105-b may also include STA 115-e in a trigger-based PPDU with a smaller resource unit (RU) or determine to not include STA 115-e in any MU transmissions. Additionally or alternatively, the extended range transmission mode may be added as part of a rate adaptation table for both an AP 105-b and STA 115-e.

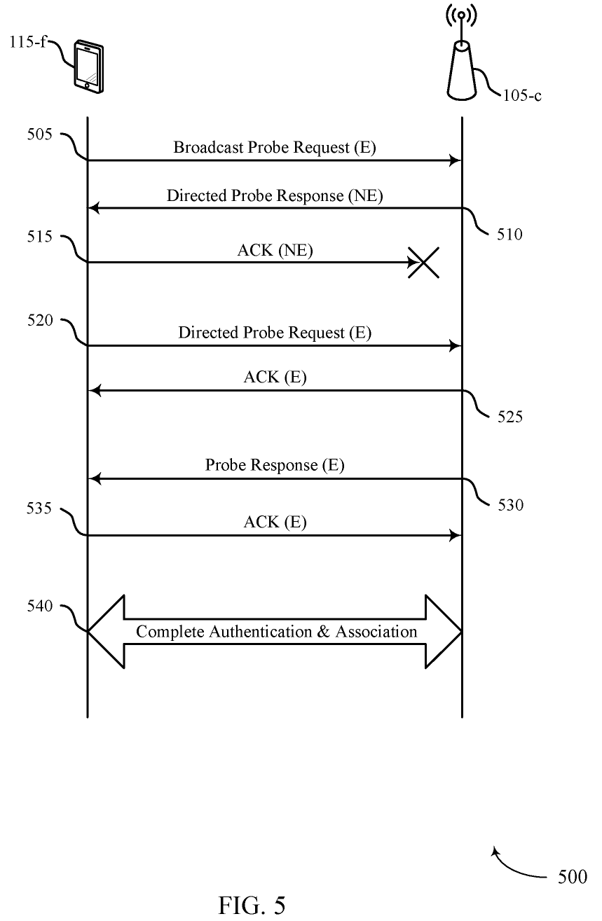

FIG. 5 illustrates an example of a process flow 500 in a system that supports extended range and non-extended range operational mode coexistence in accordance with aspects of the present disclosure. In some cases, process flow 500 may include STA 115-f and AP 105-c, which may be examples of the corresponding devices described with reference to FIGS. 1, 2, and 4. Although some of the below examples describe features performed by an AP 105, these features may also be performed by a STA 115, or by an SAP 215, as described with reference to FIGS. 2 and 4.

In some examples, STA 115-f may be configured to transmit all PPDUs (e.g., including control response frames) formatted according to an extended range transmission mode to AP 105-c (e.g., when a symmetric downlink and uplink system gain exists). Additionally, upon receipt of a frame (such as a directed probe request frame) formatted according to the extended range transmission mode from STA 115-f, AP 105-c may be configured to send control response frames formatted according to the extended range transmission mode back to STA 115-e. In some examples, AP 105-c may continue to transmit frames formatted according to the non-extended range transmission mode with other STAs 115. Process flow 500 may illustrate an example of an association and authentication procedure, where a STA 115 may connect with an AP 105 (or a SAP) using an asymmetric link or a symmetric link.

At 505, STA 115-f may broadcast, and AP 105-c may receive, a probe request, where the broadcast probe request may be formatted according to the extended range transmission mode. At 510, AP 105-c may refrain from responding to the broadcast probe request using the extended range transmission mode until AP 105-c receives a directed probe request formatted in accordance with the extended range transmission mode. That is, AP 105-c may be configured in such a way that enables extended range mode communication with STA 115-f upon receipt of a directed probe request formatted according to the extended range transmission mode. As a result, AP 105-c may transmit an association response frame (e.g., a directed probe response) formatted according to the first transmission mode (e.g., the non-extended range transmission mode).

At 515, STA 115-f may confirm receipt of the directed probe response with an ACK frame formatted according to the first transmission mode. However, in some examples, the ACK frame sent at 515 may not be received by AP 105-c (e.g., due to STA 115-f not being able to transmit at a high enough power for a signal to be reliably received by AP 105-c when using the non-extended range transmission mode).

At 520, STA 115-f may then transmit, and AP 105-c may receive, a probe request frame (e.g., a directed probe request) formatted according to the extended range mode. STA 115-f may proceed to send subsequent frame transmissions using the extended range transmission mode. Similarly, AP 105-c may be configured to communicate with STA 115-f using the extended range transmission mode, though AP 105-c may communicate with other STAs 115 using, for example, the non-extended range transmission mode.

At 525, AP 105-c may transmit an ACK frame in response to the directed probe request, and subsequently transmit a probe response frame formatted according to the extended range transmission mode at 530. At 535, STA 115-f may respond to the received probe request frame with an ACK frame formatted according to the extended range transmission mode. At 540, STA 115-f and AP 105-c may complete the association and authentication procedure to establish a connection with each other. For example, STA 115-f and AP 105-c may complete the authentication and association procedure as described with reference to FIG. 4. In some cases, STA 115-f may transmit, and AP 105-c may receive, an indication that the first transmission mode or the extended range transmission mode will be used by STA 115-f for subsequent frame transmissions.

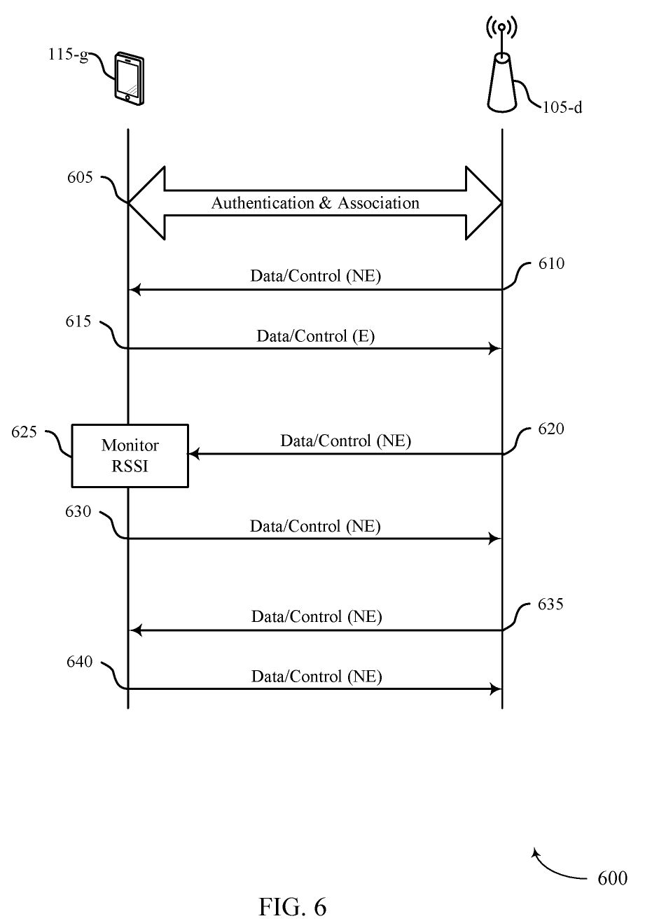

FIG. 6 illustrates an example of a process flow 600 in a system that supports extended range and non-extended range operational mode coexistence in accordance with aspects of the present disclosure. In some cases, process flow 600 may include STA 115-g and AP 105-d, which may be examples of the corresponding devices described with reference to FIGS. 1, 2, 4, and 5. Although some of the below examples describe features performed by an AP 105, these features may also be performed by a STA 115, or by an SAP 215, as described with reference to FIGS. 2, 4, and 5. Process flow 600 may illustrate an example of a refinement technique, where a STA 115 may dynamically switch transmission modes.

At 605, STA 115-g and AP 105-d may complete an association and authorization procedure to establish a connection with each other. For example, STA 115-g and AP 105-d may complete an association and authentication procedure as described with reference to FIGS. 4 and 5. At 610 and 615, STA 115-g and AP 105-d may communicate data and/or control frames formatted according to a first transmission mode or an extended range transmission mode. For instance, at 610 AP 105-d may transmit, and STA 115-g may receive, data or control frames formatted according to the first transmission mode (e.g., a non-extended range transmission mode). At 615, STA 115-g may transmit data or control frames formatted according to the extended range transmission mode that are received by AP 105-d.

At 625, STA 115-g may monitor a RSSI associated with frames received from AP 105-d that are formatted according to the first transmission mode. For example, STA 115-g may monitor the RSSI associated with frames received from AP 105-d at 625. Additionally or alternatively, STA 115-g may monitor the RSSI associated with frames received at any time from AP 105-d, such as frames received during the authentication and association procedure of 605 or frames received from AP 105-d at 610.

Following 625, STA 115-g may switch to transmitting, to AP 105-d, frames formatted according to the first transmission mode based at least in part on determining that the monitored RSSI has satisfied a predetermined threshold. For example, as part of a refinement technique, STA 115-g may determine that a link quality has improved by a predetermined amount (e.g., improved by 5-6 dB), and STA 115-g may make a determination to switch to transmitting using frames formatted according to the first transmission mode (e.g., improved received system gain (e.g., downlink) may be directly applied to the transmit system gain (e.g., uplink) due to channel reciprocity). In some cases, the determination to switch between transmission modes may be bases at least in part on a roaming policy or a roaming algorithm. In such cases, if subsequent transmissions sent by STA 115-g are successfully received by AP 105-d, STA 115-g may send an indication to AP 105-d that STA 115-g has switched to a non-extended range mode using a frame header (e.g., the indication may be sent via an OMI). Accordingly, STA 115-g may transmit subsequent data or control frames formatted according to the first transmission mode at 630. STA 115-g and AP 105-d may proceed with communication using the first transmission mode, where AP 105-d may transmit data or control frames, or both, formatted according to the first transmission mode at 635, and STA 115-g may transmit, and AP 105-d my receive, data or control frames formatted according to the first transmission mode at 635. STA 115-g may also use the refinement techniques described above to switch from the first transmission mode to the extended range transmission mode, or to coherently switch between any other transmission modes. In some examples, a control response frame (e.g., an ACK, a BA, etc.) sent in response to a frame formatted according to the extended range transmission mode may also be formatted according to the extended range transmission mode or may be formatted according to the first transmission mode. In such cases, the format of the control response frame may be based on a format of a most recently transmitted frame received by AP 105-d. For instance, the control response frame may be formatted according to the first transmission mode if a preceding frame received at AP 105-g was also formatted according to the first transmission mode.

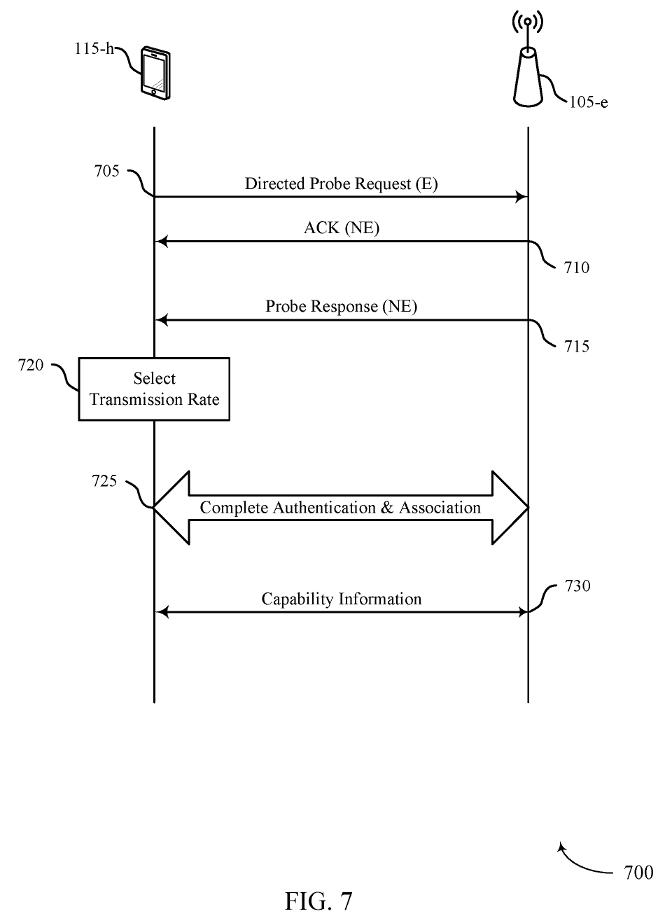

FIG. 7 illustrates an example of a process flow 700 in a system that supports extended range and non-extended range operational mode coexistence in accordance with aspects of the present disclosure. In some cases, process flow 700 may include STA 115-h and AP 105-e, which may be examples of the corresponding devices described with reference to FIGS. 1-2. Although some of the below examples describe features performed by an AP 105, these features may also be performed by a STA 115, or by an SAP 215, as described with reference to FIGS. 2 and 4 through 6. Process flow 700 may illustrate an example of rate selection based on transmission mode.

At 705, STA 115-h may transmit, and AP 105-e may receive, a probe request frame, such as a directed probe request, formatted according to an extended range transmission mode. In response, AP 105-e may transmit an ACK frame at 710, and subsequently transmit an association response frame at 715, such as a probe response frame. Based on the receipt of the directed probe request at AP 105-e, at 720, STA 115-h may select a transmission rate for one or more probe request frames formatted according to an extended range transmission mode from a rate adaptation table. In some cases, the transmission rate may be associated with AP 105-e and the extended range transmission mode. In some examples, the rate adaptation table includes, for each of a plurality of wireless devices, a first transmission rate associated with the first transmission mode and a second transmission rate associated with the extended range transmission mode. For example, the first transmission rate may specify a modulation and coding scheme (MCS), or number of spatial streams (NSS), or transmissions rate, or some combination of these, for PPDUs (e.g., for control response frames) formatted in accordance with the non-extended range transmission mode, and the second transmission rate may specify another MCS, or NSS, or transmission rate, or some combination of these, for PPDUs formatted in accordance with the extended range transmission mode. The first and second transmission rates used for transmitting frames formatted according to different transmission modes may each be selected from one or more transmission rates (e.g., 1 Mbps, 6 Mbps, different MCS values, different NSS, etc.).

At 725, STA 115-h and AP 105-e may complete an authentication and association process, where the STA may send probe request frames formatted according to the extended range transmission mode based on the selected transmission rate. At 730, STA 115-h may exchange capability information with AP 105-e, where the capability information includes an indication of available transmission modes that may be used by each device. In some examples, the exchange of capability information may be performed at one or more different times, including before, during, or after the authentication and association procedure between STA 115-h and AP 105-e. For example, capabilities may be exchanged through signaling included in a request or response frame of the authentication and association procedure at 725. In some examples, and as described above, the selection of the transmission rate may be performed any time a particular transmission mode is selected for PPDU transmissions. For instance, the transmission rate may be selected when a transmission mode is switched after the authentication and associated procedure at 725.

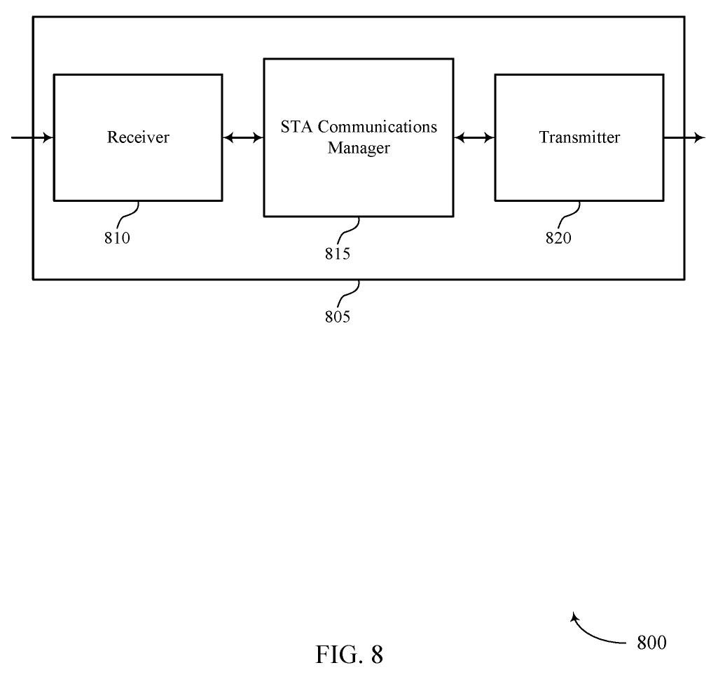

FIG. 8 shows a block diagram 800 of a wireless device 805 that supports extended range and non-extended range operational mode coexistence in accordance with aspects of the present disclosure. Wireless device 805 may be an example of aspects of a STA 115 as described with reference to FIGS. 1, 2, and 4 through 7. Wireless device 805 may include receiver 810, STA communications manager 815, and transmitter 820. Wireless device 805 may also include one or more processors, memory coupled with the one or more processors, and instructions stored in the memory that are executable by the one or more processors to enable the one or more processors to perform the roaming features discussed herein. Each of these components may be in communication with each other (e.g., via one or more buses).

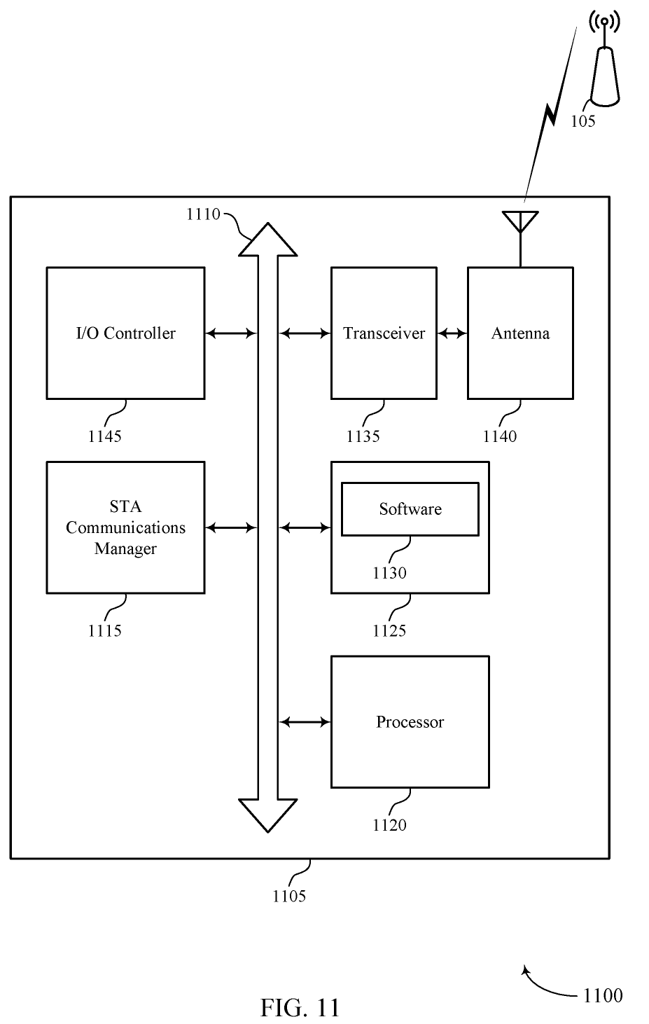

Receiver 810 may receive information such as packets, user data, or control information associated with various information channels (e.g., control channels, data channels, and information related to extended range and non-extended range operational mode coexistence, etc.). Information may be passed on to other components of the device. The receiver 810 may be an example of aspects of the transceiver 1135 described with reference to FIG. 11.

STA communications manager 815 may be an example of aspects of the STA communications manager 1115 described with reference to FIG. 11. STA communications manager 815 may broadcast a first probe request frame formatted according to an extended range transmission mode, and may receive, from the wireless device in response to the broadcast first probe request frame, a probe response frame formatted according to a first transmission mode. In some cases, STA communications manager 815 may transmit, to the wireless device in response to the received probe response frame, a second probe request frame formatted according to the first transmission mode, identify that the transmitted second probe request frame formatted according to the first transmission mode was not received by the wireless device, and determine to transmit one or more third probe request frames to the wireless device formatted according to the extended range transmission mode based on identifying that the transmitted second probe request frame formatted according to the first transmission mode was not received by the wireless device. In some cases, STA communications manager 815 may be a processor. The processor may be coupled with memory and execute instructions stored in the memory that enable the processor to perform or facilitate the transmission and reception of frames formatted according to different transmission modes discussed herein.

Transmitter 820 may transmit signals generated by other components of the device. In some examples, the transmitter 820 may be collocated with a receiver 810 in a transceiver module. For example, the transmitter 820 may be an example of aspects of the transceiver 1135 described with reference to FIG. 11. The transmitter 820 may include a single antenna, or it may include a set of antennas.

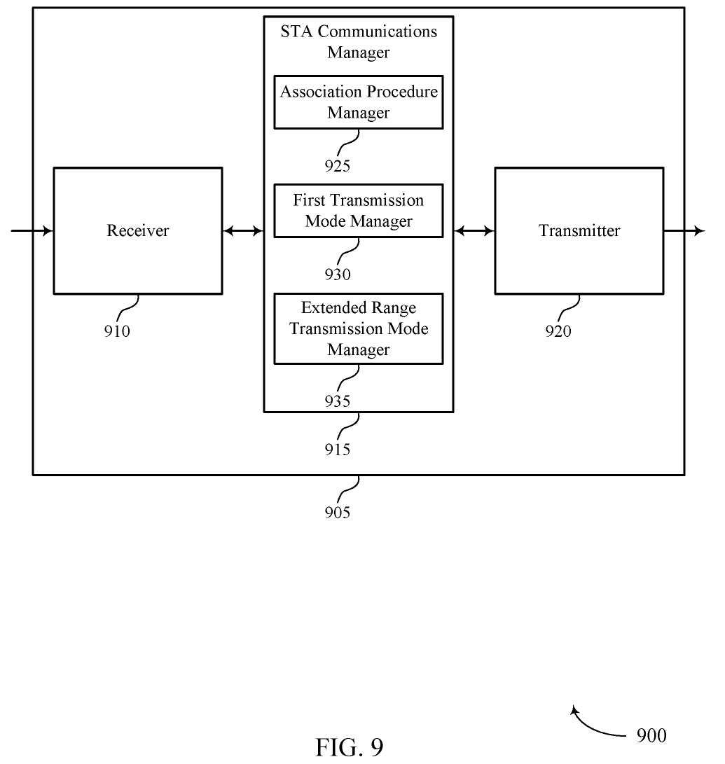

FIG. 9 shows a block diagram 900 of a wireless device 905 that supports extended range and non-extended range operational mode coexistence in accordance with aspects of the present disclosure. Wireless device 905 may be an example of aspects of a wireless device 805 or a STA 115 as described with reference to FIGS. 1, 2, and 4 through 8. Wireless device 905 may include receiver 910, STA communications manager 915, and transmitter 920. Wireless device 905 may also include a processor. Each of these components may be in communication with one another (e.g., via one or more buses).

Receiver 910 may receive information such as packets, user data, or control information associated with various information channels (e.g., control channels, data channels, and information related to extended range and non-extended range operational mode coexistence, etc.). Information may be passed on to other components of wireless device 905. The receiver 910 may be an example of aspects of the transceiver 1135 described with reference to FIG. 11. STA communications manager 915 may be an example of aspects of the STA communications manager 1115 described with reference to FIG. 11. STA communications manager 915 may also include association procedure manager 925, first transmission mode manager 930, and extended range transmission mode manager 935.

Association procedure manager 925 may broadcast a first probe request frame formatted according to an extended range transmission mode and receive, from a wireless device (e.g., an AP 105, an SAP, and the like) in response to the broadcast first probe request frame, a probe response frame formatted according to a first transmission mode. In some examples, association procedure manager 925 may complete an association and authentication procedure to establish a connection with the wireless device. In some cases, association procedure manager 925 may transmit, to the wireless device, one or more subsequent frames for an association and authentication procedure according to the extended range transmission mode while receiving, from the wireless device, frames for the association and authentication procedure formatted according to the first transmission mode, or the extended range transmission mode, or a combination thereof. In some cases, association procedure manager 925 may be a processor (e.g., a transceiver processor, or a radio processor, or a receiver processor). The processor may be coupled with memory and execute instructions stored in the memory that enable the processor to perform or facilitate the transmission and reception of frames formatted according to different transmission modes discussed herein. A transceiver processor may be collocated with and/or communicate with (e.g., direct the operations of) a transceiver of the wireless device 905. A radio processor may be collocated with and/or communicate with (e.g., direct the operations of) a radio (e.g., a Long Term Evolution (LTE) radio or a Wi-Fi radio) of wireless device 905. A receiver processor may be collocated with and/or communicate with (e.g., direct the operations of) a receiver of wireless device 905.

In some cases, wireless device 905 (e.g., a STA 115) and other wireless devices communicate using at least unlicensed radio frequency (RF) spectrum, or shared RF spectrum, or a combination thereof. In some cases, the other wireless devices include at least an AP 105, or an SAP, or another STA 115, or a combination thereof. In some cases, the received probe response frame formatted according to the first transmission mode includes at least a directed probe response, or an authentication response, or an association response, or a CTS2S transmission, or a request-to-send (RTS) transmission, or a combination thereof.

First transmission mode manager 930 may transmit, to the wireless device in response to the received probe response frame, a second probe request frame formatted according to the first transmission mode. In some examples, first transmission mode manager 930 may identify that the transmitted second probe request frame formatted according to the first transmission mode was not received by the wireless device and switch to transmitting, to the wireless device, frames formatted according to the first transmission mode. In some cases, the transmission mode switch may be based on determining that the monitored RSSI has satisfied a predetermined threshold. In some cases, the second probe request frame formatted according to the first transmission mode includes at least an ACK, or a BA, or a CTS transmission, or combination thereof. In some cases, first transmission mode manager 930 may be a processor (e.g., a transceiver processor, or a radio processor, or a transmitter processor). The processor may be coupled with memory and execute instructions stored in the memory that enable the processor to perform or facilitate the transmission of frames formatted according to the first transmission mode a discussed herein. A transmitter processor may be collocated with and/or communicate with (e.g., direct the operations of) a transmitter of wireless device 905.

Extended range transmission mode manager 935 may determine to transmit one or more third probe request frames to the wireless device formatted according to the extended range transmission mode based on identifying that the transmitted second probe request frame formatted according to the first transmission mode was not received by the wireless device. In some examples, extended range transmission mode manager 935 may transmit, to the wireless device, data or control frames formatted according to the extended range transmission mode while receiving, from the wireless device, data or control frames formatted according to the first transmission mode.

In some cases, the one or more third probe request frames include one or more single user extended range PPDUs (HE ER SU PPDUs). In some cases, the one or more third probe request frames formatted according to the extended range transmission mode include at least a directed probe request, or an authentication request, or an association request, or a combination thereof. In some cases, extended range transmission mode manager 935 may be a processor (e.g., a transceiver processor, or a radio processor, or a transmitter processor). The processor may be coupled with memory and execute instructions stored in the memory that enable the processor to perform or facilitate the transmission of frames formatted according to the extended range transmission mode a discussed herein. A transmitter processor may be collocated with and/or communicate with (e.g., direct the operations of) a transmitter of wireless device 905.

Transmitter 920 may transmit signals generated by other components of the device. In some examples, the transmitter 920 may be collocated with a receiver 910 in a transceiver module. For example, the transmitter 920 may be an example of aspects of the transceiver 1135 described with reference to FIG. 11. The transmitter 920 may include a single antenna, or it may include a set of antennas.

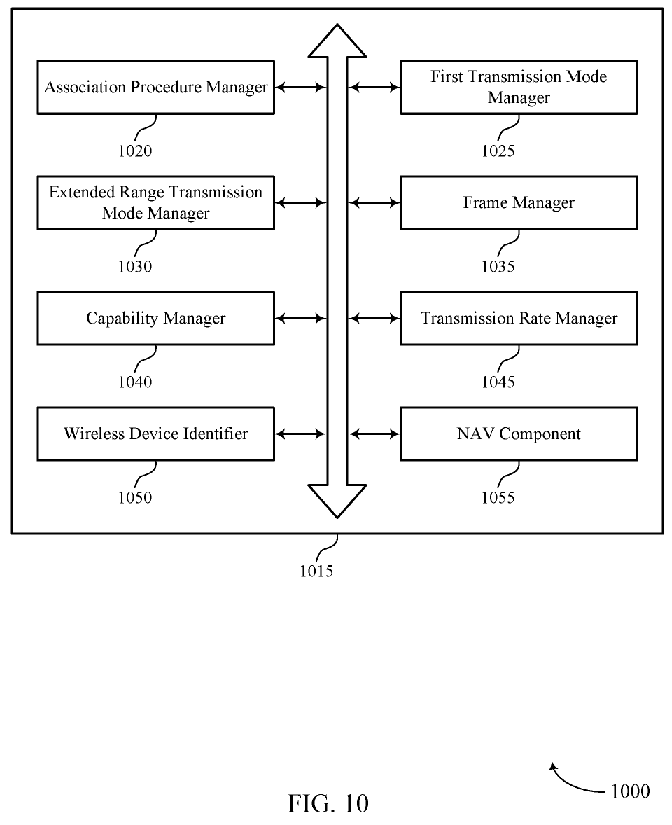

FIG. 10 shows a block diagram 1000 of a STA communications manager 1015 that supports extended range and non-extended range operational mode coexistence in accordance with aspects of the present disclosure. The STA communications manager 1015 may be an example of aspects of a STA communications manager 815, a STA communications manager 915, or a STA communications manager 1115 described with reference to FIGS. 8, 9, and 11. The STA communications manager 1015 may include association procedure manager 1020, first transmission mode manager 1025, extended range transmission mode manager 1030, frame manager 1035, capability manager 1040, transmission rate manager 1045, wireless device identifier 1050, and NAV component 1055. Each of these modules may communicate, directly or indirectly, with one another (e.g., via one or more buses).

Association procedure manager 1020 may broadcast a first probe request frame formatted according to an extended range transmission mode and receive, from the wireless device in response to the broadcast first probe request frame, a probe response frame formatted according to a first transmission mode. In some examples, association procedure manager 1020 may complete an association and authentication procedure to establish a connection with the wireless device.

In some cases, association procedure manager 1020 may transmit, to the wireless device, one or more subsequent frames for an association and authentication procedure according to the extended range transmission mode while receiving, from the wireless device, frames for the association and authentication procedure formatted according to the first transmission mode, or the extended range transmission mode, or a combination thereof. In some cases, association procedure manager 1020 may be a processor (e.g., a transceiver processor, or a radio processor, or a receiver processor). The processor may be coupled with memory and execute instructions stored in the memory that enable the processor to perform or facilitate the transmission of frames formatted according to different transmission modes discussed herein.

In some cases, the STA communications manager 1015 (e.g., as part of a STA 115) and the wireless device may communicate using at least unlicensed RF spectrum, or shared RF spectrum, or a combination thereof. In some cases, the wireless device includes at least an AP 105, or an SAP, or another STA 115, or a combination thereof. In some cases, the received probe response frame formatted according to the first transmission mode includes at least a directed probe response, or an authentication response, or an association response, or a CTS2S transmission, or an RTS transmission, or a combination thereof.

First transmission mode manager 1025 may transmit, to the wireless device in response to the received probe response frame, a second probe request frame formatted according to the first transmission mode and may identify that the transmitted second probe request frame formatted according to the first transmission mode was not received by the wireless device. In some cases, first transmission mode manager 1025 may switch to transmitting, to the wireless device, frames formatted according to the first transmission mode based on determining that a monitored RSSI has satisfied a predetermined threshold. In some cases, the one or more second probe request frames formatted according to the first transmission mode includes at least an ACK, or a BA, or a CTS transmission, or combination thereof. In some cases, first transmission mode manager 1025 may be a processor (e.g., a transceiver processor, or a radio processor, or a transmitter processor). The processor may be coupled with memory and execute instructions stored in the memory that enable the processor to perform or facilitate the transmission of frames formatted according to the first transmission mode a discussed herein. A transmitter processor may be collocated with and/or communicate with (e.g., direct the operations of) a transmitter of the device.

Extended range transmission mode manager 1030 may determine to transmit one or more third probe request frames to the wireless device formatted according to the extended range transmission mode based on identifying that the transmitted second probe request frame formatted according to the first transmission mode was not received by the wireless device. Additionally or alternatively, extended range transmission mode manager 1030 may transmit data or control frames formatted according to the extended range transmission mode while receiving, from the wireless device, data or control frames formatted according to the first transmission mode. In some cases, the one or more third probe request frames include one or more single user extended range PPDUs. In some cases, the one or more third probe request frames formatted according to the extended range transmission mode include at least a directed probe request, or an authentication request, or an association request, or a combination thereof. In some cases, extended range transmission mode manager 1030 may be a processor (e.g., a transceiver processor, or a radio processor, or a transmitter processor). The processor may be coupled with memory and execute instructions stored in the memory that enable the processor to perform or facilitate the transmission of frames formatted according to the extended range transmission mode a discussed herein. A transmitter processor may be collocated with and/or communicate with (e.g., direct the operations of) a transmitter of the device.

Frame manager 1035 may monitor an RSSI associated with frames received from the wireless device formatted according to the first transmission mode and receive one or more subsequent frames from the wireless device, where the one or more subsequent frames include a first frame formatted according to the first transmission mode or the first frame formatted according the extended range transmission mode. In some cases, receiving the one or more subsequent frames may be based on identifying a BSSID corresponding to the first frame. In some cases, the first frame includes a beacon, or broadcast data, or multicast data, or a combination thereof.

In some examples, frame manager 1035 may receive, from the wireless device, a frame formatted according to the extended range transmission mode and may determine, based at least in part on the received frame, whether to transmit, to the wireless device, a control response frame formatted according to the first transmission mode or formatted according to the extended range transmission mode. In some cases, frame manager 1035 may transmit, to the wireless device, the control response frame formatted according to the first transmission mode or formatted according to the extended range transmission mode based at least in part on the determination. In some cases, frame manager 1035 may be a processor (e.g., a transceiver processor, or a radio processor, or a receiver processor, or a processor configured to receive or monitor RF spectrum frames). The processor may be coupled with memory and execute instructions stored in the memory that enable the processor to perform or facilitate the frame monitoring features discussed herein.

Capability manager 1040 may exchange capability information with the wireless device, where the capability information includes an indication of available transmission modes. In some examples, capability manager 1040 may switch, after a completed association and authentication procedure, between transmitting frames according to the first transmission mode, or the extended range transmission mode, or a combination thereof, based at least in part an operational mode indicator within a frame from the wireless device.

In some cases, capability manager 1040 may roam between a first BSSID corresponding to the first transmission mode and a second BSSID corresponding to the extended range transmission mode, where the roaming may be based on a roaming algorithm. Additionally or alternatively, capability manager 1040 may transmit, to the wireless device, an indication that the first transmission mode or the extended range transmission mode will be used by the STA communications manager for subsequent frame transmissions. In some examples, capability manager 1040 may determine to transmit each of one or more subsequent frames formatted according to the first transmission mode, or the extended range transmission mode, or a combination thereof, and transmit, to the wireless device, each of the one or more subsequent frames formatted according to the first transmission mode, or the extended range transmission mode, or a combination thereof based on the determination. In some cases, capability manager 1040 may be a processor (e.g., processor configured to identify one or more capabilities of a wireless device). The processor may be coupled with memory and execute instructions stored in the memory that enable the processor to perform or facilitate the capability indicating features discussed herein.

Transmission rate manager 1045 may select a transmission rate for the one or more third probe request frames formatted according to the extended range transmission mode from a rate adaptation table, where the transmission rate is associated with the wireless device and the extended range transmission mode. In some cases, the rate adaptation table includes, for each of a set of wireless devices, a first transmission rate associated with the first transmission mode and a second transmission rate associated with the extended range transmission mode. In some cases, the selected transmission rate is selected from a set of transmission rates of the rate adaptation table, where each respective transmission rate may be specific to one or more of a set of wireless devices.

In some examples, transmission rate manager 1045 may select a transmission rate for the control response frame based on the determination of whether to transmit the control response frame formatted according to the first transmission mode or formatted according to the extended range transmission mode. In such cases, the transmission rate may be selected from one or more transmission rates for the first transmission mode or may be selected from one or more transmission rates for the extended range transmission mode. In some cases, transmission rate manager 1045 may be a processor (e.g., a transceiver processor, or a radio processor, or a receiver processor). The processor may be coupled with memory and execute instructions stored in the memory that enable the processor to perform or facilitate the transmission rate selection features discussed herein.

Wireless device identifier 1050 may identify the wireless device using at least a passive scanning procedure, or an active scanning procedure, or a combination thereof. In some cases, wireless device identifier 1050 may be a processor (e.g., a processor configured to identify other wireless devices). The processor may be coupled with memory and execute instructions stored in the memory that enable the processor to perform or facilitate the identification of wireless devices discussed herein. NAV component 1055 may configure a NAV based on the one or more third probe request frames. In some cases, NAV component 1055 may be a processor (e.g., a processor configured to set a NAV duration). The processor may be coupled with memory and execute instructions stored in the memory that enable the processor to perform or facilitate the NAV configuration features discussed herein.

FIG. 11 shows a diagram of a system 1100 including a device 1105 that supports extended range and non-extended range operational mode coexistence in accordance with aspects of the present disclosure. Device 1105 may be an example of or include the components of wireless device 805, wireless device 905, or a STA 115 as described above, e.g., with reference to FIGS. 1, 2, and 4 through 9. Device 1105 may include components for bi-directional voice and data communications including components for transmitting and receiving communications, including STA communications manager 1115, processor 1120, memory 1125, software 1130, transceiver 1135, antenna 1140, and I/O controller 1145. These components may be in electronic communication via one or more busses (e.g., bus 1110).

Processor 1120 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 1120 may be configured to operate a memory array using a memory controller. In other cases, a memory controller may be integrated into processor 1120. Processor 1120 may be configured to execute computer-readable instructions stored in a memory to perform various functions (e.g., features, functions or tasks supporting extended range and non-extended range operational mode coexistence).

Memory 1125 may include random access memory (RAM) and read only memory (ROM). The memory 1125 may store computer-readable, computer-executable software 1130 including instructions that, when executed, cause the processor to perform various functions described herein. In some cases, the memory 1125 may contain, among other things, a basic input/output system (BIOS) which may control basic hardware and/or software operation such as the interaction with peripheral components or devices.

Software 1130 may include code to implement aspects of the present disclosure, including code to support extended range and non-extended range operational mode coexistence. Software 1130 may be stored in a non-transitory computer-readable medium such as system memory or other memory. In some cases, the software 1130 may not be directly executable by the processor but may cause a computer (e.g., when compiled and executed) to perform functions described herein.

Transceiver 1135 may communicate bi-directionally, via one or more antennas, wired, or wireless links as described above. For example, the transceiver 1135 may represent a wireless transceiver and may communicate bi-directionally with another wireless transceiver. The transceiver 1135 may also include a modem to modulate the packets and provide the modulated packets to the antennas for transmission, and to demodulate packets received from the antennas. In some cases, the wireless device may include a single antenna 1140. However, in some cases the device may have more than one antenna 1140, which may be capable of concurrently transmitting or receiving multiple wireless transmissions.

I/O controller 1145 may manage input and output signals for device 1105. I/O controller 1145 may also manage peripherals not integrated into device 1105. In some cases, I/O controller 1145 may represent a physical connection or port to an external peripheral. In some cases, I/O controller 1145 may utilize an operating system such as iOS®, ANDROID®, MS-DOS®, MS-WINDOWS®, OS/2®, UNIX®, LINUX®, or another known operating system.

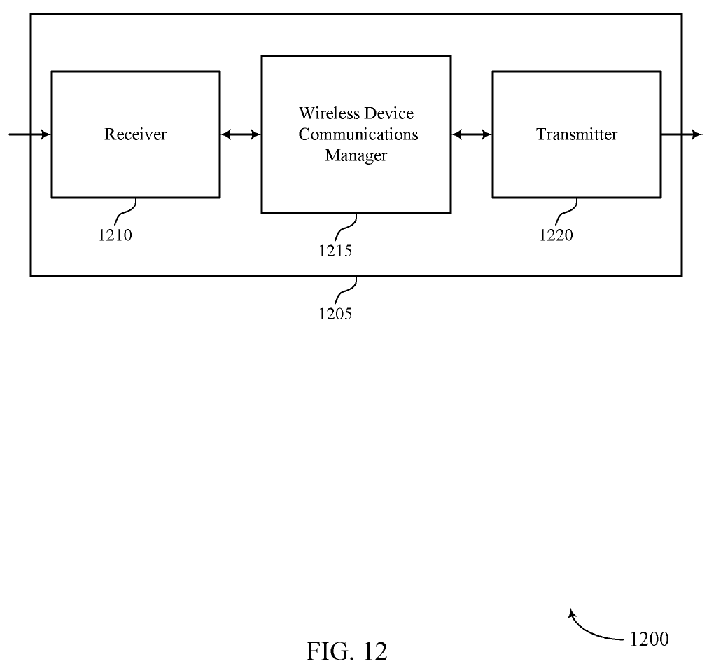

FIG. 12 shows a block diagram 1200 of a wireless device 1205 that supports extended range and non-extended range operational mode coexistence in accordance with aspects of the present disclosure. Wireless device 1205 may be an example of aspects of an AP 105 (or SAP) as described with reference to FIGS. 1, 2, and 4 through 7. Wireless device 1205 may include receiver 1210, wireless device communications manager 1215, and transmitter 1220. Wireless device 1205 may also include one or more processors, memory coupled with the one or more processors, and instructions stored in the memory that are executable by the one or more processors to enable the one or more processors to perform the roaming features discussed herein. Each of these components may be in communication with each other (e.g., via one or more buses).

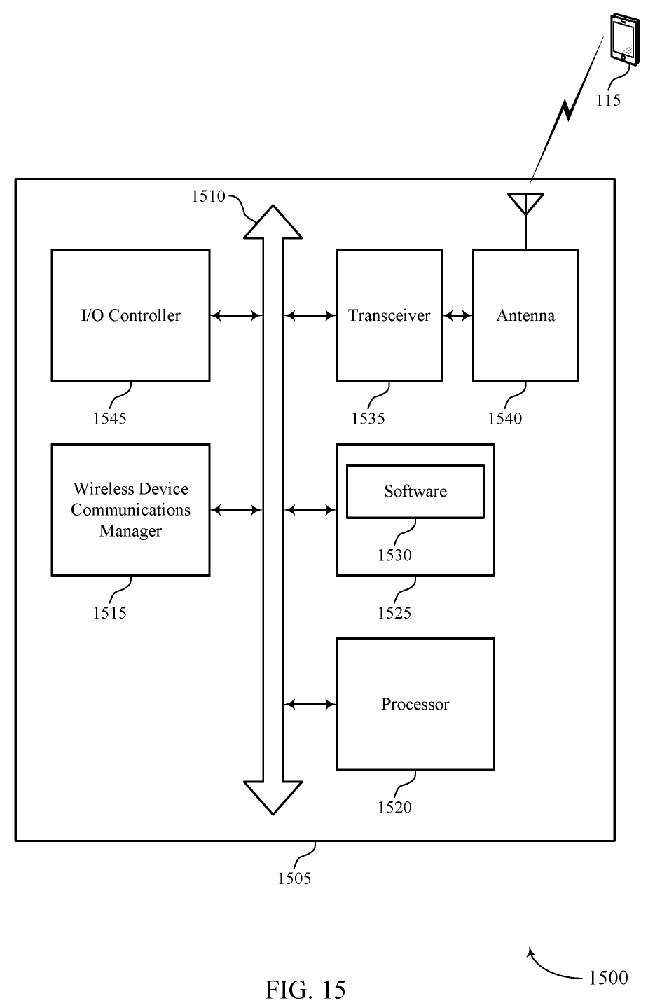

Receiver 1210 may receive information such as packets, user data, or control information associated with various information channels (e.g., control channels, data channels, and information related to extended range and non-extended range operational mode coexistence, etc.). Information may be passed on to other components of the device. The receiver 1210 may be an example of aspects of the transceiver 1535 described with reference to FIG. 15.

Wireless device communications manager 1215 may be an example of aspects of the wireless device communications manager 1515 described with reference to FIG. 15. Wireless device communications manager 1215 may receive, from an STA 115, a broadcast first probe request frame formatted according to an extended range transmission mode and transmit, a first probe response frame in response to the received broadcast probe request frame, the first probe response frame formatted according to a first transmission mode. In some examples, wireless device communications manager 1215 may receive, from the STA 115 in response to the first probe response frame, a second probe request frame formatted according to the extended range transmission mode, and may determine, based on the received second probe request frame, whether to transmit, to the STA 115, one or more subsequent probe response frames formatted according to the first transmission mode, or according to the extended range transmission mode, or formatted according to a combination thereof. In some cases, wireless device communications manager 1215 may transmit the one or more subsequent probe response frames to the STA 115 based on the determination. In some cases, wireless device communications manager 1215 may be a processor. The processor may be coupled with memory and execute instructions stored in the memory that enable the processor to perform or facilitate the transmission of frames formatted according to different transmission modes discussed herein.

Transmitter 1220 may transmit signals generated by other components of the device. In some examples, the transmitter 1220 may be collocated with a receiver 1210 in a transceiver module. For example, the transmitter 1220 may be an example of aspects of the transceiver 1535 described with reference to FIG. 15. The transmitter 1220 may include a single antenna, or it may include a set of antennas.

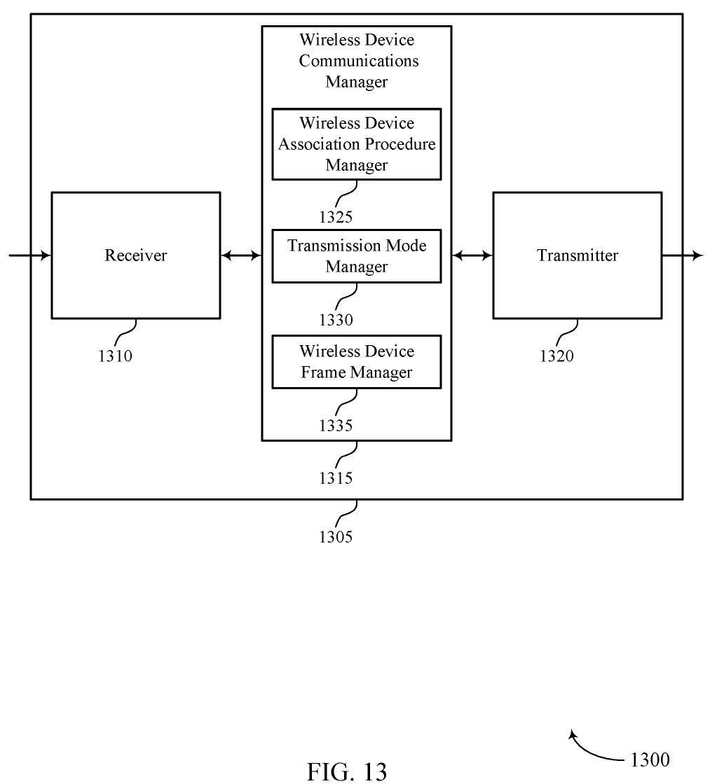

FIG. 13 shows a block diagram 1300 of a wireless device 1305 that supports extended range and non-extended range operational mode coexistence in accordance with aspects of the present disclosure. Wireless device 1305 may be an example of aspects of a wireless device 1205, an AP 105, or an SAP as described with reference to FIGS. 1, 2, 4 through 7, and 12. Wireless device 1305 may include receiver 1310, wireless device communications manager 1315, and transmitter 1320. Wireless device 1305 may also include a processor. Each of these components may be in communication with one another (e.g., via one or more buses).

Receiver 1310 may receive information such as packets, user data, or control information associated with various information channels (e.g., control channels, data channels, and information related to extended range and non-extended range operational mode coexistence, etc.). Information may be passed on to other components of the device. The receiver 1310 may be an example of aspects of the transceiver 1535 described with reference to FIG. 15.

Wireless device communications manager 1315 may be an example of aspects of the wireless device communications manager 1515 described with reference to FIG. 15. Wireless device communications manager 1315 may also include wireless device association procedure manager 1325, transmission mode manager 1330, and wireless device frame manager 1335. In some cases, the wireless device communications manager 1315 may be a processor. The processor may be coupled with memory and execute instructions stored in the memory that enable the processor to perform or facilitate the transmission of frames formatted according to different transmission modes discussed herein.

Wireless device association procedure manager 1325 may receive, from a STA 115, a broadcast first probe request frame formatted according to an extended range transmission mode and transmit, a first probe response frame in response to the received broadcast probe request frame, the first probe response frame formatted according to a first transmission mode. In some cases, wireless device association procedure manager 1325 may receive, from the STA 115 in response to the first probe response frame, a second probe request frame formatted according to the extended range transmission mode. In some cases, wireless device association procedure manager 1325 may be a processor (e.g., a transceiver processor, or a radio processor, or a receiver processor). The processor may be coupled with memory and execute instructions stored in the memory that enable the processor to perform or facilitate the association and authentication features discussed herein. A transceiver processor may be collocated with and/or communicate with (e.g., direct the operations of) a transceiver of the device. A radio processor may be collocated with and/or communicate with (e.g., direct the operations of) a radio (e.g., an LTE radio or a Wi-Fi radio) of the device. A receiver processor may be collocated with and/or communicate with (e.g., direct the operations of) a receiver of wireless device 1305.

Transmission mode manager 1330 may determine, based on the received second probe request frame, whether to transmit, to the STA 115, one or more subsequent probe response frames formatted according to the first transmission mode, or according to the extended range transmission mode, or formatted according to a combination thereof. In some cases, transmission mode manager 1330 may be a processor (e.g., a transceiver processor, or a radio processor, or a transmitter processor). The processor may be coupled with memory and execute instructions stored in the memory that enable the processor to perform or facilitate the determination of different transmission modes discussed herein. A transmitter processor may be collocated with and/or communicate with (e.g., direct the operations of) a transmitter of wireless device 1305.

Wireless device frame manager 1335 may transmit the one or more subsequent probe response frames to the STA 115 based on the determination. In some cases, wireless device frame manager 1335 may transmit the first frame formatted according to the extended range transmission mode, where the first frame formatted according to the extended range transmission mode is separated from the first frame formatted according to the first transmission mode by a predefined interval. In some examples transmitting the first frame formatted according to the first transmission mode includes broadcasting or multicasting the first frame formatted according to the first transmission mode. Additionally or alternatively, transmitting the first frame formatted according to the extended range transmission mode includes broadcasting or multicasting the first frame formatted according to the extended range transmission mode.

In some cases, transmitting the first frame formatted according to the extended range transmission mode includes broadcasting or multicasting the first frame formatted according to the extended range transmission mode. In some cases, transmitting the one or more subsequent association response frames includes transmitting a first frame formatted according to the first transmission mode. In some cases, the predefined interval is less than a DTIM interval. In some cases, the first frame includes at least a beacon, or a control frame, or data, or a combination thereof. In some cases, wireless device frame manager 1335 may be a processor (e.g., a transceiver processor, or a radio processor, or a transmitter processor). The processor may be coupled with memory and execute instructions stored in the memory that enable the processor to perform or facilitate the frame transmission features discussed herein. A transmitter processor may be collocated with and/or communicate with (e.g., direct the operations of) a transmitter of wireless device 1305.

Transmitter 1320 may transmit signals generated by other components of the device. In some examples, the transmitter 1320 may be collocated with a receiver 1310 in a transceiver module. For example, the transmitter 1320 may be an example of aspects of the transceiver 1535 described with reference to FIG. 15. The transmitter 1320 may include a single antenna, or it may include a set of antennas.

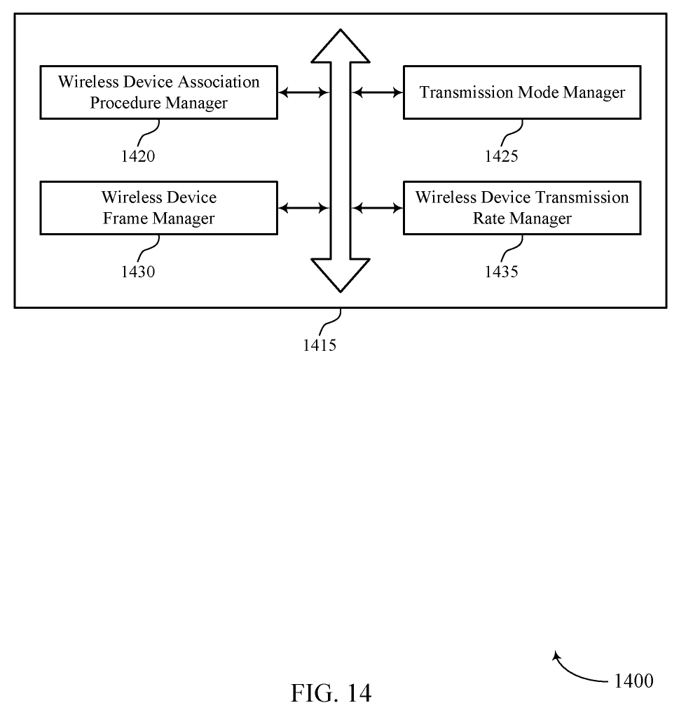

FIG. 14 shows a block diagram 1400 of a wireless device communications manager 1415 that supports extended range and non-extended range operational mode coexistence in accordance with aspects of the present disclosure. The wireless device communications manager 1415 may be an example of aspects of a wireless device communications manager 1515 described with reference to FIGS. 12, 13, and 15. The wireless device communications manager 1415 may include wireless device association procedure manager 1420, transmission mode manager 1425, wireless device frame manager 1430, and wireless device transmission rate manager 1435. Each of these modules may communicate, directly or indirectly, with one another (e.g., via one or more buses).

Wireless device association procedure manager 1420 may receive, from an STA 115, a broadcast first probe request frame formatted according to an extended range transmission mode. In some cases, wireless device association procedure manager 1420 may transmit a first probe response frame in response to the received broadcast probe request frame, the first probe response frame formatted according to a first transmission mode, and receive, from the STA 115 in response to the first probe response frame, a second probe request frame formatted according to the extended range transmission mode. In some cases, the wireless device association procedure manager 1420 may be a processor (e.g., a transceiver processor, or a radio processor, or a receiver processor). The processor may be coupled with memory and execute instructions stored in the memory that enable the processor to perform or facilitate the association and authentication features discussed herein.

Transmission mode manager 1425 may determine, based on the received second probe request frame, whether to transmit, to the STA 115, one or more subsequent probe response frames formatted according to the first transmission mode, or according to the extended range transmission mode, or formatted according to a combination thereof. In some cases, transmission mode manager 1425 may be a processor (e.g., a transceiver processor, or a radio processor, or a transmitter processor). The processor may be coupled with memory and execute instructions stored in the memory that enable the processor to perform or facilitate the determination of different transmission modes discussed herein. A transmitter processor may be collocated with and/or communicate with (e.g., direct the operations of) a transmitter of the device.

Wireless device frame manager 1430 may transmit the one or more subsequent probe response frames to the STA 115 based on the determination. In some examples, wireless device frame manager 1430 may transmit the first frame formatted according to the extended range transmission mode, where the first frame formatted according to the extended range transmission mode is separated from the first frame formatted according to the first transmission mode by a predefined interval. In some cases, transmitting the first frame formatted according to the first transmission mode includes broadcasting or multicasting the first frame formatted according to the first transmission mode. In some cases, transmitting the first frame formatted according to the extended range transmission mode includes broadcasting or multicasting the first frame formatted according to the extended range transmission mode.

In some cases, transmitting the one or more subsequent probe response frames includes transmitting a first frame formatted according to the first transmission mode. In some cases, the predefined interval is less than a DTIM interval. In some cases, the first frame includes at least a beacon, or a control frame, or data, or a combination thereof. In some cases, wireless device frame manager 1430 may be a processor (e.g., a transceiver processor, or a radio processor, or a transmitter processor, or a processor configured to receive or transmit RF spectrum frames). The processor may be coupled with memory and execute instructions stored in the memory that enable the processor to perform or facilitate the frame transmission features discussed herein. A transmitter processor may be collocated with and/or communicate with (e.g., direct the operations of) a transmitter of the device.

Wireless device transmission rate manager 1435 may select a transmission rate for the one or more subsequent probe response frames from a rate adaptation table, where the transmission rate is associated with the STA 115 and the extended range transmission mode. In some cases, wireless device transmission rate manager 1435 may be a processor (e.g., a transceiver processor, or a radio processor, or a receiver processor). The processor may be coupled with memory and execute instructions stored in the memory that enable the processor to perform or facilitate the transmission rate selection features discussed herein.

FIG. 15 shows a diagram of a system 1500 including a device 1505 that supports extended range and non-extended range operational mode coexistence in accordance with aspects of the present disclosure. Device 1505 may be an example of or include the components of AP 105 or SAP as described above, e.g., with reference to FIGS. 1, 2, 4 through 7, and 12 through 14. Device 1505 may include components for bi-directional voice and data communications including components for transmitting and receiving communications, including wireless device communications manager 1515, processor 1520, memory 1525, software 1530, transceiver 1535, antenna 1540, and I/O controller 1545. These components may be in electronic communication via one or more busses (e.g., bus 1510).

Processor 1520 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1520 may be configured to operate a memory array using a memory controller. In other cases, a memory controller may be integrated into processor 1520. Processor 1520 may be configured to execute computer-readable instructions stored in a memory to perform various functions (e.g., features, functions or tasks supporting extended range and non-extended range operational mode coexistence).1520.

Memory 1525 may include RAM and ROM. The memory 1525 may store computer-readable, computer-executable software 1530 including instructions that, when executed, cause the processor to perform various functions described herein. In some cases, the memory 1525 may contain, among other things, a BIOS which may control basic hardware and/or software operation such as the interaction with peripheral components or devices.

Software 1530 may include code to implement aspects of the present disclosure, including code to support extended range and non-extended range operational mode coexistence. Software 1530 may be stored in a non-transitory computer-readable medium such as system memory or other memory. In some cases, the software 1530 may not be directly executable by the processor but may cause a computer (e.g., when compiled and executed) to perform functions described herein.

Transceiver 1535 may communicate bi-directionally, via one or more antennas, wired, or wireless links as described above. For example, the transceiver 1535 may represent a wireless transceiver and may communicate bi-directionally with another wireless transceiver. The transceiver 1535 may also include a modem to modulate the packets and provide the modulated packets to the antennas for transmission, and to demodulate packets received from the antennas. In some cases, the wireless device may include a single antenna 1540. However, in some cases the device may have more than one antenna 1540, which may be capable of concurrently transmitting or receiving multiple wireless transmissions.

I/O controller 1545 may manage input and output signals for device 1505. I/O controller 1545 may also manage peripherals not integrated into device 1505. In some cases, I/O controller 1545 may represent a physical connection or port to an external peripheral. In some cases, I/O controller 1545 may utilize an operating system such as iOS®, ANDROID®, MS-DOS®, MS-WINDOWS®, OS/2®, UNIX®, LINUX®, or another known operating system.

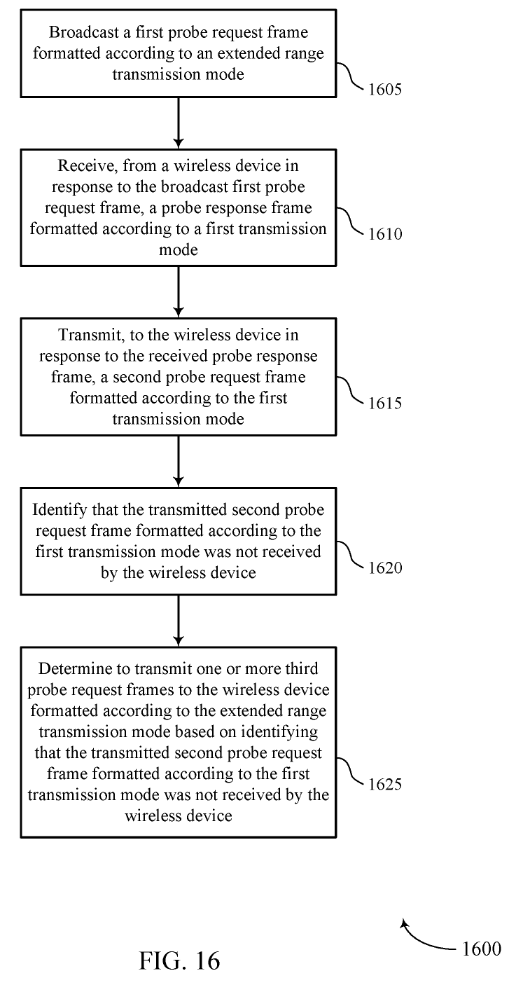

FIG. 16 shows a flowchart illustrating a method 1600 for extended range and non-extended range operational mode coexistence in accordance with aspects of the present disclosure. The operations of method 1600 may be implemented by a STA 115 or its components as described herein. For example, the operations of method 1600 may be performed by a STA communications manager as described with reference to FIGS. 8 through 11. In some examples, a STA 115 may execute a set of codes to control the functional elements of the device to perform the functions described below. Additionally or alternatively, the STA 115 may perform aspects of the functions described below using special-purpose hardware.

At block 1605 the STA 115 may broadcast a first probe request frame formatted according to an extended range transmission mode. The operations of block 1605 may be performed according to the methods described with reference to FIGS. 1 through 7. In some examples, aspects of the operations of block 1605 may be performed by an association procedure manager as described with reference to FIGS. 8 through 11.

At block 1610 the STA 115 may receive, from a wireless device in response to the broadcast first probe request frame, a probe response frame formatted according to a first transmission mode. The operations of block 1610 may be performed according to the methods described with reference to FIGS. 1 through 7. In some examples, aspects of the operations of block 1610 may be performed by an association procedure manager as described with reference to FIGS. 8 through 11.

At block 1615 the STA 115 may transmit, to the wireless device in response to the received probe response frame, a second probe request frame formatted according to the first transmission mode. The operations of block 1615 may be performed according to the methods described with reference to FIGS. 1 through 7. In some examples, aspects of the operations of block 1615 may be performed by a first transmission mode manager as described with reference to FIGS. 8 through 11.

At block 1620 the STA 115 may identify that the transmitted second probe request frame formatted according to the first transmission mode was not received by the wireless device. The operations of block 1620 may be performed according to the methods described with reference to FIGS. 1 through 7. In some examples, aspects of the operations of block 1620 may be performed by a first transmission mode manager as described with reference to FIGS. 8 through 11.

At block 1625 the STA 115 may determine to transmit one or more third probe request frames to the wireless device formatted according to the extended range transmission mode based on identifying that the transmitted second probe request frame formatted according to the first transmission mode was not received by the wireless device. The operations of block 1625 may be performed according to the methods described with reference to FIGS. 1 through 7. In some examples, aspects of the operations of block 1625 may be performed by an extended range transmission mode manager as described with reference to FIGS. 8 through 11.

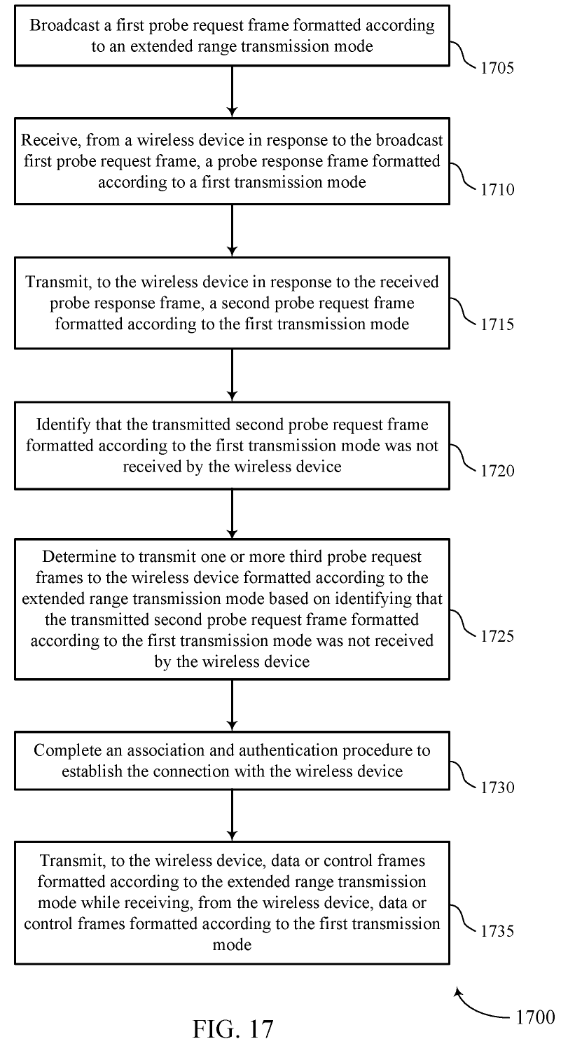

FIG. 17 shows a flowchart illustrating a method 1700 for extended range and non-extended range operational mode coexistence in accordance with aspects of the present disclosure. The operations of method 1700 may be implemented by a STA 115 or its components as described herein. For example, the operations of method 1700 may be performed by a STA communications manager as described with reference to FIGS. 8 through 11. In some examples, a STA 115 may execute a set of codes to control the functional elements of the device to perform the functions described below. Additionally or alternatively, the STA 115 may perform aspects of the functions described below using special-purpose hardware.

At block 1705 the STA 115 may broadcast a first probe request frame formatted according to an extended range transmission mode. The operations of block 1705 may be performed according to the methods described with reference to FIGS. 1 through 7. In some examples, aspects of the operations of block 1705 may be performed by an association procedure manager as described with reference to FIGS. 8 through 11.

At block 1710 the STA 115 may receive, from a wireless device in response to the broadcast first probe request frame, a probe response frame formatted according to a first transmission mode. The operations of block 1710 may be performed according to the methods described with reference to FIGS. 1 through 7. In some examples, aspects of the operations of block 1710 may be performed by an association procedure manager as described with reference to FIGS. 8 through 11.

At block 1715 the STA 115 may transmit, to the wireless device in response to the received probe response frame, a second probe request frame formatted according to the first transmission mode. The operations of block 1715 may be performed according to the methods described with reference to FIGS. 1 through 7. In some examples, aspects of the operations of block 1715 may be performed by a first transmission mode manager as described with reference to FIGS. 8 through 11.

At block 1720 the STA 115 may identify that the transmitted second probe request frame formatted according to the first transmission mode was not received by the wireless device. The operations of block 1720 may be performed according to the methods described with reference to FIGS. 1 through 7. In some examples, aspects of the operations of block 1720 may be performed by a first transmission mode manager as described with reference to FIGS. 8 through 11.

At block 1725 the STA 115 may determine to transmit one or more third probe request frames to the wireless device formatted according to the extended range transmission mode based on identifying that the transmitted second probe request frame formatted according to the first transmission mode was not received by the wireless device. The operations of block 1725 may be performed according to the methods described with reference to FIGS. 1 through 7. In some examples, aspects of the operations of block 1725 may be performed by an extended range transmission mode manager as described with reference to FIGS. 8 through 11.

At block 1730 the STA 115 may complete an association and authentication procedure to establish the connection with the wireless device. The operations of block 1730 may be performed according to the methods described with reference to FIGS. 1 through 7. In some examples, aspects of the operations of block 1730 may be performed by an association procedure manager as described with reference to FIGS. 8 through 11.

At block 1735 the STA 115 may transmit, to the wireless device, data or control frames formatted according to the extended range transmission mode while receiving, from the wireless device, data or control frames formatted according to the first transmission mode. The operations of block 1735 may be performed according to the methods described with reference to FIGS. 1 through 7. In some examples, aspects of the operations of block 1735 may be performed by an extended range transmission mode manager as described with reference to FIGS. 8 through 11.

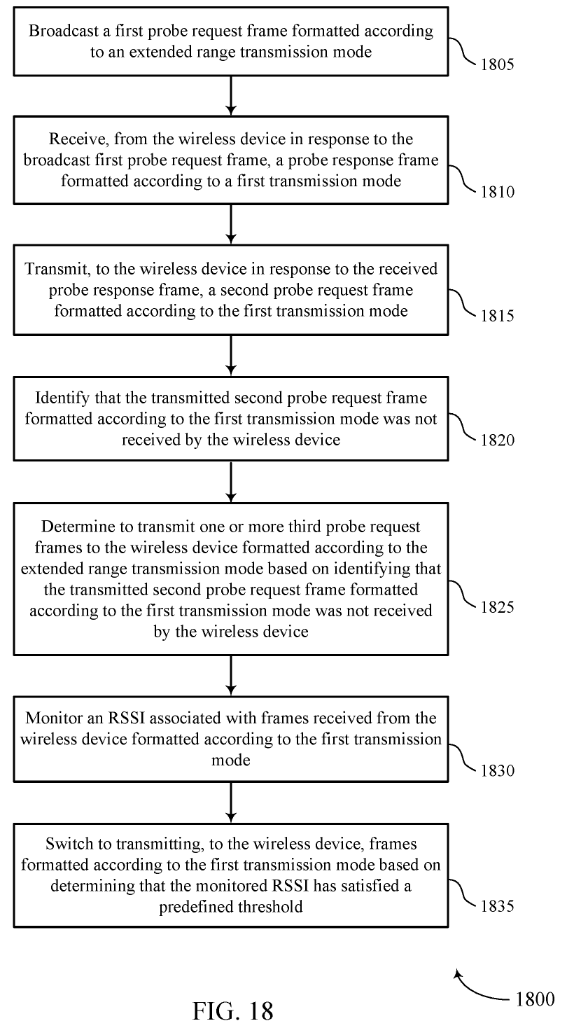

FIG. 18 shows a flowchart illustrating a method 1800 for extended range and non-extended range operational mode coexistence in accordance with aspects of the present disclosure. The operations of method 1800 may be implemented by a STA 115 or its components as described herein. For example, the operations of method 1800 may be performed by a STA communications manager as described with reference to FIGS. 8 through 11. In some examples, a STA 115 may execute a set of codes to control the functional elements of the device to perform the functions described below. Additionally or alternatively, the STA 115 may perform aspects of the functions described below using special-purpose hardware.

At block 1805 the STA 115 may broadcast a first probe request frame formatted according to an extended range transmission mode. The operations of block 1805 may be performed according to the methods described with reference to FIGS. 1 through 7. In some examples, aspects of the operations of block 1805 may be performed by an association procedure manager as described with reference to FIGS. 8 through 11.

At block 1810 the STA 115 may receive, from the wireless device in response to the broadcast first probe request frame, a probe response frame formatted according to a first transmission mode. The operations of block 1810 may be performed according to the methods described with reference to FIGS. 1 through 7. In some examples, aspects of the operations of block 1810 may be performed by an association procedure manager as described with reference to FIGS. 8 through 11.

At block 1815 the STA 115 may transmit, to the wireless device in response to the received probe response frame, a second probe request frame formatted according to the first transmission mode. The operations of block 1815 may be performed according to the methods described with reference to FIGS. 1 through 7. In some examples, aspects of the operations of block 1815 may be performed by a first transmission mode manager as described with reference to FIGS. 8 through 11.

At block 1820 the STA 115 may identify that the transmitted second probe request frame formatted according to the first transmission mode was not received by the wireless device. The operations of block 1820 may be performed according to the methods described with reference to FIGS. 1 through 7. In some examples, aspects of the operations of block 1820 may be performed by a first transmission mode manager as described with reference to FIGS. 8 through 11.

At block 1825 the STA 115 may determine to transmit one or more third probe request frames to the wireless device formatted according to the extended range transmission mode based on identifying that the transmitted second probe request frame formatted according to the first transmission mode was not received by the wireless device. The operations of block 1825 may be performed according to the methods described with reference to FIGS. 1 through 7. In some examples, aspects of the operations of block 1825 may be performed by an extended range transmission mode manager as described with reference to FIGS. 8 through 11.

At block 1830 the STA 115 may monitor a received signal strength indicator (RSSI) associated with frames received from the wireless device formatted according to the first transmission mode. The operations of block 1830 may be performed according to the methods described with reference to FIGS. 1 through 7. In some examples, aspects of the operations of block 1830 may be performed by a frame manager as described with reference to FIGS. 8 through 11.

At block 1835 the STA 115 may switch to transmitting, to the wireless device, frames formatted according to the first transmission mode based on determining that the monitored RSSI has satisfied a predetermined threshold. The operations of block 1835 may be performed according to the methods described with reference to FIGS. 1 through 7. In some examples, aspects of the operations of block 1835 may be performed by a first transmission mode manager as described with reference to FIGS. 8 through 11.

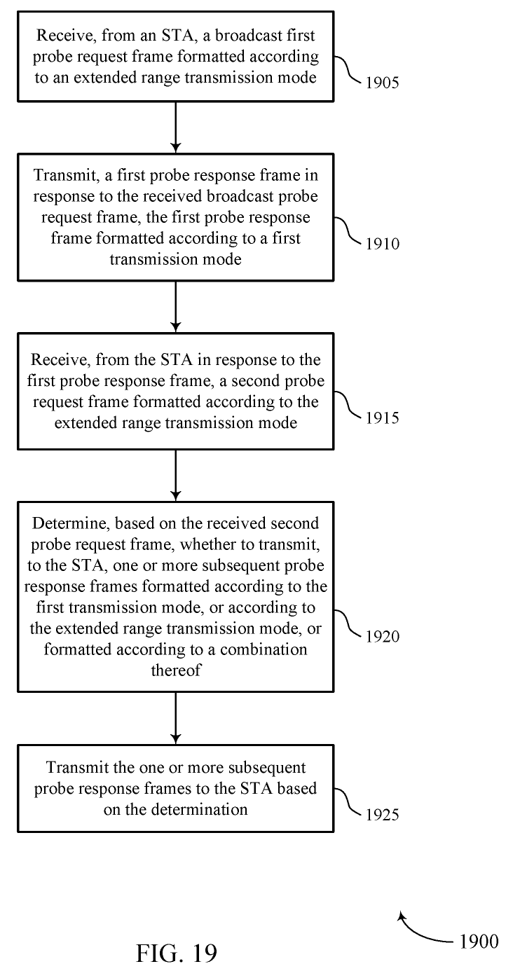

FIG. 19 shows a flowchart illustrating a method 1900 for extended range and non-extended range operational mode coexistence in accordance with aspects of the present disclosure. The operations of method 1900 may be implemented by a wireless device, such as an AP 105 or its components as described herein. For example, the operations of method 1900 may be performed by a wireless device communications manager as described with reference to FIGS. 12 through 15. In some examples, an AP 105 may execute a set of codes to control the functional elements of the device to perform the functions described below. Additionally or alternatively, the AP 105 may perform aspects of the functions described below using special-purpose hardware.

At block 1905 the AP 105 may receive, from a STA 115, a broadcast first probe request frame formatted according to an extended range transmission mode. The operations of block 1905 may be performed according to the methods described with reference to FIGS. 1 through 7. In some examples, aspects of the operations of block 1905 may be performed by a wireless device association procedure manager as described with reference to FIGS. 12 through 15.

At block 1910 the AP 105 may transmit, a first probe response frame in response to the received broadcast probe request frame, the first probe response frame formatted according to a first transmission mode. The operations of block 1910 may be performed according to the methods described with reference to FIGS. 1 through 7. In some examples, aspects of the operations of block 1910 may be performed by a wireless device association procedure manager as described with reference to FIGS. 12 through 15.

At block 1915 the AP 105 may receive, from the STA 115 in response to the first probe response frame, a second probe request frame formatted according to the extended range transmission mode. The operations of block 1915 may be performed according to the methods described with reference to FIGS. 1 through 7. In some examples, aspects of the operations of block 1915 may be performed by a wireless device association procedure manager as described with reference to FIGS. 12 through 15.

At block 1920 the AP 105 may determine, based on the received second probe request frame, whether to transmit, to the STA 115, one or more subsequent probe response frames formatted according to the first transmission mode, or according to the extended range transmission mode, or formatted according to a combination thereof. The operations of block 1920 may be performed according to the methods described with reference to FIGS. 1 through 7. In some examples, aspects of the operations of block 1920 may be performed by a transmission mode manager as described with reference to FIGS. 12 through 15.

At block 1925 the AP 105 may transmit the one or more subsequent probe response frames to the STA 115 based on the determination. The operations of block 1925 may be performed according to the methods described with reference to FIGS. 1 through 7. In some examples, aspects of the operations of block 1925 may be performed by a wireless device frame manager as described with reference to FIGS. 12 through 15.

In some examples, aspects from two or more of the methods 1600, 1700, 1800 or 1900 described with reference to FIG. 16, 17, 18, or 19 may be combined. It should be noted that the methods 1600, 1700, 1800 and 1900 are just example implementations, and that the operations of the methods 1600, 1700, 1800 or 1900 may be rearranged or otherwise modified such that other implementations are possible.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the STAs may have similar frame timing, and transmissions from different STAs may be approximately aligned in time. For asynchronous operation, the STAs may have different frame timing, and transmissions from different STAs may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates an inclusive list such that, for example, a phrase referring to “at least one of” a list of items refers to any combination of those items, including single members. As an example, “at least one of: A, B, or C” is intended to cover A, B, C, A-B, A-C, B-C, and A-B-C., as well as any combination with multiples of the same element (e.g., A-A, A-A-A, A-A-B, A-A-C, A-B-B, A-C-C, B-B, B-B-B, B-B-C, C-C, and C-C-C or any other ordering of A, B, and C).

Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, comprising:
a processor;
memory in electronic communication with the processor; and
instructions stored in the memory and operable, when executed by the processor, to cause the apparatus to:
broadcast a first probe request frame formatted according to an extended range transmission mode;
receive, from a wireless device in response to the broadcast first probe request frame, a probe response frame formatted according to a first transmission mode;
transmit, to the wireless device in response to the received probe response frame, a second probe request frame formatted according to the first transmission mode;
identify that the transmitted second probe request frame formatted according to the first transmission mode was not received by the wireless device; and
determine to transmit one or more third probe request frames to the wireless device formatted according to the extended range transmission mode based at least in part on identifying that the transmitted second probe request frame formatted according to the first transmission mode was not received by the wireless device.

2. The apparatus of claim 1, wherein the instructions are further executable by the processor to cause the apparatus to:
complete an association and authentication procedure to establish a connection with the wireless device; and
transmit, to the wireless device, data or control frames formatted according to the extended range transmission mode while receiving, from the wireless device, data or control frames formatted according to the first transmission mode.

3. The apparatus of claim 1, wherein the instructions are further executable by the processor to cause the apparatus to:
monitor a received signal strength indicator (RSSI) associated with frames received from the wireless device formatted according to the first transmission mode; and
switch to transmitting, to the wireless device, frames formatted according to the first transmission mode based at least in part on determining that the monitored RSSI has satisfied a predetermined threshold.

4. The apparatus of claim 1, wherein the instructions are further executable by the processor to cause the apparatus to:
select a transmission rate for the one or more third probe request frames formatted according to the extended range transmission mode from a rate adaptation table, wherein the transmission rate is associated with the wireless device and the extended range transmission mode.

5. The apparatus of claim 4, wherein the rate adaptation table comprises, for each of a plurality of wireless devices, a first transmission rate associated with the first transmission mode and a second transmission rate associated with the extended range transmission mode.

6. The apparatus of claim 4, wherein the selected transmission rate is selected from a plurality of transmission rates of the rate adaptation table, each respective transmission rate specific to one or more of a plurality of wireless devices.

7. The apparatus of claim 1, wherein the instructions are further executable by the processor to cause the apparatus to:
receive, from the wireless device, a frame formatted according to the extended range transmission mode;
determine, based at least in part on the received frame, whether to transmit, to the wireless device, a control response frame formatted according to the first transmission mode or formatted according to the extended range transmission mode; and
transmit, to the wireless device, the control response frame formatted according to the first transmission mode or formatted according to the extended range transmission mode based at least in part on the determination.

8. The apparatus of claim 7, wherein the instructions are further executable by the processor to cause the apparatus to:
select a transmission rate for the control response frame based at least in part on the determination, wherein the transmission rate is selected from one or more transmission rates for the first transmission mode or selected from one or more transmission rates for the extended range transmission mode.

9. The apparatus of claim 1, wherein the instructions are further executable by the processor to cause the apparatus to:
switch, after a completed association and authentication procedure, between transmitting frames according to the first transmission mode, or the extended range transmission mode, or a combination thereof, based at least in part an operational mode indicator within a frame from the wireless device.

10. The apparatus of claim 1, wherein the instructions are further executable by the processor to cause the apparatus to:
roam between a first basic service set identifier (BSSID) corresponding to the first transmission mode and a second BSSID corresponding to the extended range transmission mode, wherein the roaming is based at least in part on a roaming algorithm.

11. The apparatus of claim 1, wherein the instructions are further executable by the processor to cause the apparatus to:
transmit, to the wireless device, an indication that the first transmission mode or the extended range transmission mode will be used by a station for subsequent frame transmissions.

12. The apparatus of claim 1, wherein the instructions are further executable by the processor to cause the apparatus to:
transmit, to the wireless device, one or more subsequent frames for an association and authentication procedure according to the extended range transmission mode while receiving, from the wireless device, frames for the association and authentication procedure formatted according to the first transmission mode, or the extended range transmission mode, or a combination thereof.

13. The apparatus of claim 1, wherein the instructions are further executable by the processor to cause the apparatus to:
receive one or more subsequent frames from the wireless device, wherein the one or more subsequent frames comprise a first frame formatted according to the first transmission mode or the first frame formatted according the extended range transmission mode, and wherein receiving the one or more subsequent frames is based at least in part on identifying a basic service set identifier (BSSID) corresponding to the first frame.

14. The apparatus of claim 1, wherein the instructions are further executable by the processor to cause the apparatus to:
determine to transmit each of one or more subsequent frames formatted according to the first transmission mode, or the extended range transmission mode, or a combination thereof; and
transmit, to the wireless device, the one or more subsequent frames formatted according to the first transmission mode, or the extended range transmission mode, or a combination thereof based at least in part on the determination.

15. The apparatus of claim 1, wherein the received probe response frame formatted according to the first transmission mode comprises at least a directed probe response, or an authentication response, or an association response, or a clear-to-send-to-self (CTS2S) transmission, or a request-to-send (RTS) transmission, or a combination thereof.

16. The apparatus of claim 1, wherein the second probe request frame formatted according to the first transmission mode comprises at least an acknowledgement, or a block acknowledgement, or a clear-to-send (CTS) transmission, or combination thereof.

17. The apparatus of claim 1, wherein the apparatus is a wireless communication terminal and further comprises an antenna and a transceiver.

18. An apparatus for wireless communication, comprising:
a processor;
memory in electronic communication with the processor; and
instructions stored in the memory and operable, when executed by the processor, to cause the apparatus to:
receive, from a station, a broadcast first probe request frame formatted according to an extended range transmission mode;
transmit, a first probe response frame in response to the received broadcast probe request frame, the first probe response frame formatted according to a first transmission mode;
receive, from the station in response to the first probe response frame, a second probe request frame formatted according to the extended range transmission mode;
determine, based at least in part on the received second probe request frame, whether to transmit, to the station, one or more subsequent probe response frames formatted according to the first transmission mode, or according to the extended range transmission mode, or formatted according to a combination thereof; and
transmit the one or more subsequent probe response frames to the station based at least in part on the determination.

19. The apparatus of claim 18, wherein:
the instructions executable by the processor to cause the apparatus to transmit the one or more subsequent probe response frames comprise instructions executable by the processor to cause the apparatus to transmit a first frame formatted according to the first transmission mode; and
the instructions are further executable by the processor to cause the apparatus to transmit the first frame formatted according to the extended range transmission mode, wherein the first frame formatted according to the extended range transmission mode is separated from the first frame formatted according to the first transmission mode by a predefined interval.

20. The apparatus of claim 18, wherein the instructions are further executable by the processor to cause the apparatus to:
select a transmission rate for the one or more subsequent probe response frames from a rate adaptation table, wherein the transmission rate is associated with the station and the extended range transmission mode.

21. A method for wireless communication at a station, comprising:
broadcasting a first probe request frame formatted according to an extended range transmission mode;
receiving, from a wireless device in response to the broadcast first probe request frame, a probe response frame formatted according to a first transmission mode;
transmitting, to the wireless device in response to the received probe response frame, a second probe request frame formatted according to the first transmission mode;
identifying that the transmitted second probe request frame formatted according to the first transmission mode was not received by the wireless device; and
determining to transmit one or more third probe request frames to the wireless device formatted according to the extended range transmission mode based at least in part on identifying that the transmitted second probe request frame formatted according to the first transmission mode was not received by the wireless device.

22. The method of claim 21, further comprising:
completing an association and authentication procedure to establish a connection with the wireless device; and
transmitting, to the wireless device, data or control frames formatted according to the extended range transmission mode while receiving, from the wireless device, data or control frames formatted according to the first transmission mode.

23. The method of claim 21, further comprising:
monitoring a received signal strength indicator (RSSI) associated with frames received from the wireless device formatted according to the first transmission mode; and
switching to transmitting, to the wireless device, frames formatted according to the first transmission mode based at least in part on determining that the monitored RSSI has satisfied a predetermined threshold.

24. The method of claim 21, further comprising:
selecting a transmission rate for the one or more third probe request frames formatted according to the extended range transmission mode from a rate adaptation table, wherein the transmission rate is associated with the wireless device and the extended range transmission mode.

25. The method of claim 21, further comprising:
receiving, from the wireless device, a frame formatted according to the extended range transmission mode;
determining, based at least in part on the received frame, whether to transmit, to the wireless device, a control response frame formatted according to the first transmission mode or formatted according to the extended range transmission mode; and
transmitting, to the wireless device, the control response frame formatted according to the first transmission mode or formatted according to the extended range transmission mode based at least in part on the determination.

26. The method of claim 25, further comprising:
selecting a transmission rate for the control response frame based at least in part on the determination, wherein the transmission rate is selected from one or more transmission rates for the first transmission mode or selected from one or more transmission rates for the extended range transmission mode.

25. The method of claim 21, further comprising:
switching, after a completed association and authentication procedure, between transmitting frames according to the first transmission mode, or the extended range transmission mode, or a combination thereof, based at least in part an operational mode indicator within a frame from the wireless device.

26. The method of claim 21, further comprising:
roaming between a first basic service set identifier (BSSID) corresponding to the first transmission mode and a second BSSID corresponding to the extended range transmission mode, wherein the roaming is based at least in part on a roaming algorithm.

27. The method of claim 21, further comprising:
receiving one or more subsequent frames from the wireless device, wherein the one or more subsequent frames comprise a first frame formatted according to the first transmission mode or the first frame formatted according the extended range transmission mode, and wherein receiving the one or more subsequent frames is based at least in part on identifying a basic service set identifier (BSSID) corresponding to the first frame.

28. A method for wireless communication at a wireless device, comprising:
receiving, from a station, a broadcast first probe request frame formatted according to an extended range transmission mode;
transmitting, a first probe response frame in response to the received broadcast probe request frame, the first probe response frame formatted according to a first transmission mode;
receiving, from the station in response to the first probe response frame, a second probe request frame formatted according to the extended range transmission mode;
determining, based at least in part on the received second probe request frame, whether to transmit, to the station, one or more subsequent probe response frames formatted according to the first transmission mode, or according to the extended range transmission mode, or formatted according to a combination thereof; and
transmitting the one or more subsequent probe response frames to the station based at least in part on the determination.
